(19) United States
(12) Patent Application Publication
(10) Pub. No.: US 2026/0192701 A1
(43) Pub. Date: Jul. 9, 2026

(54) QUICK-SWAP DEVICE, BATTERY PACK, ELECTRIC VEHICLE AND CONTROL METHOD THEREFOR

(71) Applicants: AULTON NEW ENERGY CO., LTD., Guangzhou, Guangdong (CN); SHANGHAI DIANBA NEW ENERGY TECHNOLOGY CO., LTD., Shanghai (CN)

(72) Inventors: Jianping Zhang, Shanghai (CN); Chunhua Huang, Shanghai (CN)

(21) Appl. No.: 19/134,314

(22) PCT Filed: Dec. 4, 2023
(86) PCT No.: PCT/CN2023/136260

§ 371 Date: May 30, 2025

(30) Foreign Application Priority Data
Dec. 2, 2022 (CN) 202211543340.X

(51) Int. Cl. B60L 53/80; B60K 1/04; B60L 58/27; H01M 10/615; H01M 10/625; H01M 10/657; H05B 3/54

(52) U.S. Cl. CPC B60L 53/80; B60K 1/04; B60L 58/27; H01M 10/615; H01M 10/625; H01M 10/657; H05B 3/54; B60K 2001/0455; H05B 2203/014; H05B 2203/02

(57) ABSTRACT

A quick-swap device (100), a battery pack (200), an electric vehicle (1000) and a control method therefor are provided. The quick-swap device (100) comprises a quick-swap bracket (1) and a first heating portion (2), wherein the first heating portion (2) is connected to the quick-swap bracket (1) and is configured to heat the quick-swap bracket (1); and the quick-swap bracket (1) is heated by the first heating portion (2), to prevent failure in quick swapping of the battery pack (200) caused when the quick-swap bracket (1) and the battery pack (200) are frozen under extreme low temperatures such as snow or freezing rain.

The present disclosure claims priority to Chinese Patent Application No. 202211543340X filed on Dec. 2, 2022, the entire contents of which are incorporated herein by reference.

### TECHNICAL FIELD

The present disclosure relates to a quick-swap device, a battery pack, an electric vehicle and a control method therefor.

### BACKGROUND

At present, the emission of automobile exhaust remains an important contributor to environmental pollution problems. To control automobile exhaust emissions, natural gas vehicles, hydrogen-fueled vehicles, solar powered vehicles, and electric vehicles have been developed to replace oil-fueled vehicles, while electric vehicles show the most promising application prospects. The existing electric vehicles mainly include two types: direct-charging vehicles and quick-swap vehicles. Due to limitations of charging time and location, many new energy electric vehicles are gradually adopting a mode of quick battery swapping for energy replenishment. The quick-swap electric vehicles are equipped with quick-swap brackets for mounting battery packs. When the battery is swapped, the battery swapping device of a battery swapping station moves below the electric vehicle and is positioned relative to the quick-swap bracket of the electric vehicle. However, under extreme low-temperature conditions such as freezing rain and heavy snow in cold regions, the battery pack and the quick-swap bracket may be frozen, and the battery pack cannot be quickly swapped.

### SUMMARY

The technical problem to be solved by the present disclosure is to overcome the defect of the prior art that the battery pack and the quick-swap bracket are frozen under extreme low-temperature conditions such as freezing rain and heavy snow in cold regions, and the battery pack cannot be quickly swapped, and to provide a quick-swap device, a battery pack, an electric vehicle and a control method therefor.

The present disclosure solves the above technical problem through the following technical solutions:

A quick-swap device is provided, and the quick-swap device includes a quick-swap bracket and a first heating portion, wherein the first heating portion is connected to the quick-swap bracket and is configured to heat the quick-swap bracket.

In this solution, the battery pack is connected to the quick-swap bracket. With the above structural form, the quick-swap bracket is heated by the first heating portion, to prevent the quick-swap bracket and the battery pack from being frozen under extreme low-temperature conditions such as heavy snow or freezing rain and prevent failure in quick battery swapping, such that the battery packs can be quickly swapped normally, and the efficiency of quick swapping of the battery pack in cold regions is improved. In addition, the above structural form avoids damage to the battery pack and the quick-swap bracket caused by forced battery swapping, and prolongs the service life of the battery pack and the quick-swap bracket.

Preferably, the quick-swap bracket includes a first bracket and a locking mechanism, wherein the locking mechanism is arranged on the first bracket, the first heating portion is at least arranged on the first bracket, and the first heating portion is configured to heat at least the locking mechanism.

In this solution, the battery pack is connected to the locking mechanism to achieve the connection between the battery pack and the quick-swap bracket. With the above structural form, the first heating portion is configured to heat at least the locking mechanism, thereby preventing failure in disassembling the battery pack caused when the battery pack and the locking mechanism are frozen together, ensuring that the battery packs in cold regions can be quickly swapped normally, and improving the efficiency of quick swapping of battery packs in cold regions. In addition, the above structural form avoids damage to the battery pack and the first bracket caused by forced battery swapping, and prolongs the service life of the battery pack and the first bracket.

Preferably, the first bracket is provided with a first mounting surface for mounting the locking mechanism, the first heating portion is at least arranged on the first mounting surface, and/or the first heating portion is at least arranged on a side of the quick-swap bracket deviating from the first mounting surface.

In this solution, the first heating portion is at least arranged on the first mounting surface, and the key-position locking mechanism can be directly heated by the first heating portion, thereby preventing failure in disassembling the battery pack caused when the connection positions between battery pack and the locking mechanism are frozen together. The above structural form is adopted to improve the efficiency of heating the locking mechanism by the first heating portion, such that the first heating portion can consume lower energy to prevent the quick-swap bracket and the battery pack from being frozen. The first heating portion first heats the side of the quick-swap bracket deviating from the first mounting surface, and transfers the heat to a first heating surface and then to a locking mechanism through heat conduction, thereby heating the locking mechanism by the first heating portion, and then preventing failure in disassembling the battery pack caused when the connection positions between battery pack and the locking mechanism are frozen together. The above structural form can be adopted to prevent interference between the first heating portion and the locking mechanism, such that both the first heating portion and the locking mechanism can work normally, the battery pack can be stably connected to the locking mechanism, and the stability and reliability of the connection of the battery pack to the quick-swap bracket are improved.

Preferably, the first heating portion is wound around the first bracket along an extension direction of the first bracket.

In this solution, the above structural form is adopted to facilitate the arrangement of the first heating portion, such that the first heating portion is fixed more firmly, the contact area between the first heating portion and the first bracket is increased, and the heating efficiency of the first heating portion is improved.

Preferably, the first heating portion is spirally wound or directly wound around the first bracket along an extension direction.

In this solution, the above structural form is adopted to further facilitate the arrangement of the first heating portion, such that the first heating portion is fixed more firmly, the contact area between the first heating portion and the first bracket is further increased, and the heating efficiency of the first heating portion is further improved.

Preferably, the locking mechanism includes a plurality of lock bases, and an extension direction of the first heating portion is the same as a distribution direction of the plurality of lock bases.

In this solution, with the above structural form, the first heating portion can heat a plurality of lock bases, such that the first heating portion heats the first bracket more evenly, and the gap between each lock base and the battery pack and the gap between the battery pack and the first bracket can be prevented from being frozen, and then the battery pack and the first bracket can be separated normally, thereby ensuring that the battery packs in cold regions can be quickly swapped normally, and improving the efficiency of quick swapping of battery packs in cold regions.

Preferably, the first heating portion includes a first heating member, and the first heating member is arranged at a corresponding position of the lock base to heat the lock base.

In this solution, the above structural form is adopted to improve the heat conduction efficiency of the first heating portion, thereby preventing the lock base and the locking member on the battery pack from being frozen together, ensuring that the battery packs in cold regions can be quickly swapped normally, and further improving the efficiency of quick swapping of the battery packs.

Preferably, the first heating member is attached to the surface of the first bracket connected to the lock base;
and/or, the first heating member is wound around the first bracket along a distribution direction of the lock base.

In this solution, the above structural form is adopted to enhance the heating of the key-position lock base by the first heating portion, and compared with other arrangements, the first heating portion can consume lower energy to prevent the quick-swap bracket and the battery pack from being frozen. The first heating portion is wrapped around the first bracket along the distribution direction of the lock base, and a reliable and effective heating member arrangement solution is provided to facilitate the mounting of the first heating member, such that the first heating portion is fixed more firmly, the contact area between the first heating portion and the first bracket is increased, and the heating efficiency of the first heating portion is improved.

Preferably, the widths of the first heating portion along its length extension direction are different.

In this solution, with the above structural form, the area of the first heating portion can be increased in regions prone to icing and freezing, to improve the heating efficiency of the first heating portion in a freezing region, ensure uniform heating of the quick-swap bracket, and demonstrate such characteristics as saving heating materials and good economy.

Preferably, the width of the first heating portion close to the locking mechanism is greater than the widths of other regions.

In this solution, the above structural form is adopted to increase the contact area between the first heating portion and the locking mechanism and improve the heating effect of the first heating portion on the locking mechanism, thereby preventing the locking mechanism and the battery pack from being frozen, ensuring that the battery packs in cold regions can be quickly swapped normally, and improving the efficiency of battery pack swapping.

Preferably, the first bracket includes a first bracket body and at least one first bending portion, wherein the locking mechanism is arranged on the first bracket body, the first bending portion is bent from the first bracket body towards a direction away from the locking mechanism, the first bending portion extends along the length direction of the first bracket, and the first heating portion is arranged at the junction between the first bending portion and the first bracket body.

In this solution, with the above structural form, the first heating portion is placed at a bending point of the first bending portion, to protect the first heating portion by the first bending portion, and prolong the service life of the first heating portion. In addition, the first bending portion is arranged to improve the structural strength of the first bracket and prolong the service life of the first bracket.

Preferably, the first heating portion includes electric heating wires, a plurality of electric heating wires are arranged, and the plurality of electric heating wires are arranged in parallel at the junction between the first bending portion and the first bracket body.

In this solution, the above structural form is adopted to facilitate the arrangement of the heating wires. In addition, since the electric heating wires can be compressed and bent, the electric heating wires can be effectively attached to the surface of the first bracket, thereby increasing the heating area of the first bracket and improving the heating efficiency of the first heating portion on the first bracket.

Preferably, the first heating portion is arranged on a side of the first bracket body deviating from the locking mechanism.

In this solution, interference between the first heating portion and the locking mechanism can be prevented, such that both the first heating portion and the locking mechanism can work normally, the battery pack can be stably connected to the locking mechanism, and the stability and reliability of the connection of the battery pack to the bracket body are improved.

Preferably, the first heating portion includes a plurality of heating films, wherein the heating films are connected to the surface of the first bracket, and the distribution of the plurality of heating films corresponds to the distribution of the plurality of lock bases.

In this solution, with the above structural form, the heating film can heat the plurality of locking mechanisms, the heating film heats the first bracket more evenly, and the gap between each locking mechanism and the battery pack and the gap between the battery pack and the first bracket can be prevented from being frozen, furthermore, the battery pack and the first bracket can be separated normally, and the efficiency of quick swapping of battery packs in cold regions can be improved.

Preferably, a plurality of heating films on the same side are connected in series.

In this solution, the above structural form is adopted to improve the heating efficiency of the heating film.

Preferably, the first heating portion further includes connection members, and the plurality of heating films are electrically connected through the connection members.

In this solution, with the above structural form, the plurality of heating films are connected by connection members, to improve the stability of the connection between the heating film and the first bracket. The plurality of heating films are connected to a power supply through the first connection member, thereby simplifying the heating structure and ensuring the heating efficiency.

Preferably, the connection member is located on a side of the first bracket deviating from the locking mechanism.

In this solution, with the above structural form, the space for mounting the locking mechanism on the first bracket is not occupied, and interference between the connection member and the locking mechanism can be prevented, such that both the connection member and the locking mechanism can work normally, and the battery pack can be stably connected to the locking mechanism.

Preferably, the first heating portion further includes a PTC plate, the PTC plate is connected to the first bracket, and the distribution direction of the PTC plate is the same as the extension direction of the first bracket.

In this solution, with the above structural form, the first bracket is heated by the PTC plate, to prevent failure in swapping the battery pack caused when the lock base and the battery pack are frozen. The distribution direction of the PTC plate is the same as the extension direction of the first bracket, thereby ensuring the uniformity of the heating of the first bracket by the PTC plate.

Preferably, the quick-swap bracket further includes a second bracket, the first bracket and the second bracket enclose a frame structure, and the first heating portion is at least arranged on the second bracket.

In this solution, the frame structure is configured to accommodate the battery pack, such that the battery pack can be protected by the frame structure, and the service life of the battery pack is prolonged. In addition, the above structural form can be adopted to prevent the second bracket and the battery pack from being frozen, such that the second bracket and the battery pack can be separated normally, and the battery can be swapped normally in cold regions. Preferably, the first heating portion is attached to the surface of the second bracket;
and/or, the first heating portion is wound around the second bracket along an extension direction of the second bracket.

In this solution, the above structural form is adopted to facilitate the heating of the second bracket by the first heating portion and improve the heating efficiency of the second bracket by the first heating portion. The above structural form facilitates the arrangement of the first heating portion, such that the first heating portion is fixed more firmly, the contact area between the first heating portion and the second bracket is increased, and the heating efficiency of the first heating portion is improved.

Preferably, the first heating portion is wound along extension directions of the first bracket and the second bracket.

In this solution, the above structural form is adopted to further facilitate the arrangement of the first heating portion, such that the first heating portion is fixed more firmly, the contact area between the first heating portion and the quick-swap bracket is increased, and the heating efficiency of the first heating portion is further improved.

Preferably, the first heating portion includes one or more of an electric heating wire, a heating film, a heating plate, a heating belt, an electric heating belt, and a heating tracing belt.

A battery pack is provided, and the battery pack includes a second heating portion, wherein the second heating portion is configured to heat the battery pack body.

In this solution, the battery pack is connected to the quick-swap bracket. With the above structural form, the battery pack is heated by the second heating portion to prevent the quick-swap bracket and the battery pack from being frozen under extreme weather such as extreme freezing rain or heavy snow, such that the battery pack and the quick-swap bracket can be separated normally, the battery packs can be quickly swapped normally, and the efficiency of quick swapping of battery packs in cold regions is improved. In addition, the above structural form avoids damage to the battery pack and the quick-swap bracket caused by forced battery swapping, and prolongs the service life of the battery pack and the quick-swap bracket.

Preferably, the battery pack includes a battery pack body, and the second heating portion is connected to the battery pack body.

In this solution, the battery pack body is connected to the quick-swap bracket. With the above structural form, the battery pack body is heated by the second heating portion, to prevent the quick-swap bracket and the battery pack body from being frozen under extreme weather such as extreme freezing rain or heavy snow, such that the battery pack body and the quick-swap bracket can be separated normally, the battery pack body can be quickly swapped normally, and the efficiency of quick swapping of battery packs in cold regions is improved. In addition, the above structural form avoids damage to the battery pack body and the quick-swap bracket caused by forced battery swapping, and prolongs the service life of the battery pack body and the quick-swap bracket.

Preferably, the battery pack includes a locking member, the locking member is arranged on the battery pack body, and the second heating portion and the locking member are connected to the same side of the battery pack body.

In this solution, with the above structural arrangement, the locking member is connected to the locking mechanism on the quick-swap bracket to achieve connection with the quick-swap bracket. The second heating portion and the locking member are connected to the same side of the battery pack body, and the second heating portion can heat the locking member, thereby preventing failure in quick swapping of the battery pack caused when the connection positions between the locking member and the locking mechanism are frozen together, and ensuring that the battery packs in cold regions can be quickly swapped normally. The above structural form is adopted to improve the heating efficiency of the second heating portion on the locking member, thereby improving the efficiency of quick swapping of battery packs in cold regions. In addition, the above structural form avoids damage to the battery pack and the quick-swap bracket caused by forced battery swapping, and prolongs the service life of the battery pack and the quick-swap bracket.

Preferably, a gap is formed between the second heating portion and the locking member.

In this solution, with the above structural form, the heat generated by the second heating portion can be transferred to the locking member through heat conduction, thereby heating the locking member by the second heating portion, and preventing failure in quick swapping of battery packs caused when the connection positions between the locking member and the locking mechanism on the quick-swap bracket are frozen together. The above structural form can be adopted to prevent interference between the second heating portion and the locking member, such that both the second heating portion and the locking member can work normally, the battery pack body can be stably connected to the locking mechanism, and the stability and reliability of the connection of the battery pack to the quick-swap bracket are improved.

Preferably, the battery pack includes a positioning member spaced apart from the locking member, and a gap is formed between the second heating portion and the positioning member.

In this solution, with the above structural form, the heat generated by the second heating portion can be transferred to the positioning member through heat conduction, and interference between the second heat conduction portion and the positioning portion can be prevented, such that the positioning member can play a guiding role normally in the mounting process of the quick-swap battery pack, the quick-swap battery pack can be aligned accurately with the vehicle body, and the mounting accuracy of the quick-swap battery pack is improved.

Preferably, the battery pack further includes a surrounding frame and a battery pack body, wherein the surrounding frame is circumferentially arranged around the battery pack body, the surrounding frame is provided with an accommodation cavity, and the second heating portion is arranged in the accommodation cavity.

In this solution, with the above structural form, the surrounding frame is circumferentially arranged around the battery pack body, and the battery pack body can be protected by the surrounding frame, to prevent damage to the battery pack body caused when external objects collide with the battery pack body, and prolong the service life of the battery pack body. In addition, the second heating portion is arranged in the accommodation cavity, and the second heating portion can also be protected by the surrounding frame, to prevent damage to the second heating portion caused when external objects collide with the second heating portion, and prolong the service life of the second heating portion.

Preferably, the locking member is arranged on a side of the surrounding frame away from the battery pack body, and the second heating portion is arranged on a side of the accommodation cavity close to the locking member.

In this solution, the above structural form is adopted to improve the heat conduction efficiency of the second heating portion, thereby preventing the locking mechanism and the locking member on the quick-swap bracket from being frozen together, ensuring that the battery packs in cold regions can be quickly swapped normally, and further improving the efficiency of quick swapping of the battery packs.

Preferably, the second heating portion is attached to the battery pack body or the surrounding frame;
and/or, the second heating portion is wound around the locking member.

In the present solution, the above structural form is adopted to facilitate the heating of the battery pack body or the surrounding frame by the second heating portion, thereby facilitating the heating of the locking member by the second heating portion, and improving the heating efficiency of the battery pack body or the surrounding frame by the second heating portion; and the above structural form is adopted to facilitate the arrangement of the second heating portion, such that the second heating portion is fixed more firmly, the contact area between the second heating portion and the locking member is increased, and the heating efficiency of the second heating portion is improved.

Preferably, the second heating portion is one or more of a heating plate, a heating belt, an electric heating belt, a heating film, a heating tracing belt, and an electric heating wire;
and/or, the second heating portion includes a connection member and a plurality of heating films, and the plurality of heating films are electrically connected through the connection member;
and/or, the heating film is provided with a through hole, and the through hole is configured to be sleeved on the locking member.

In this solution, with the above structural form, a plurality of heating films are connected to the power supply through connection members, to simplify the heating structure and ensure the heating efficiency; in addition, the through hole formed on the heating film is sleeved on the locking member, and the locking member can be directly heated by the heating film, thereby improving the heating efficiency.

An electric vehicle is provided, and the electric vehicle includes the quick-swap device described above and/or the battery pack described above.

In this solution, the quick-swap device is applied to the electric vehicle, such that the battery pack can be connected to the quick-swap bracket, and the battery pack is connected to the electric vehicle. With the above structural form, the quick-swap bracket is heated by the first heating portion, and the battery pack is heated by the second heating portion, to prevent the quick-swap bracket and the battery pack from being frozen under extreme weather such as extreme freezing rain or heavy snow, such that the battery pack and the quick-swap bracket can be separated normally, the battery packs can be quickly swapped normally, and the efficiency of quick swapping of battery packs in cold regions is improved. In addition, the above structural form avoids damage to the battery pack and the quick-swap bracket caused by forced battery swapping, and prolongs the service life of the battery pack and the quick-swap bracket.

Preferably, the quick-swap bracket is a body frame of the vehicle or is arranged on the body frame of the vehicle.

Preferably, the first heating portion and/or the second heating portion are electrically connected to a vehicle power distribution box or the battery pack.

In this solution, with the above structural form, the first heating portion can be powered by the vehicle distribution box or the battery pack, thereby ensuring that the first heating portion can normally heat the quick-swap bracket, preventing the battery pack and the quick-swap bracket from being frozen, and ensuring normal battery swapping in cold regions.

Preferably, the electric vehicle further includes a temperature detection portion, and the temperature detection portion is configured to detect the temperature of the quick-swap device and/or the battery pack.

In this solution, with the above structural form, the temperature of the quick-swap device can be detected in real time through the temperature detection portion, and the safety of heating is ensured.

Preferably, the temperature detection portion includes a plurality of temperature detection members, and the plurality of temperature detection members are arranged corresponding to the locking mechanism and/or the locking member.

In this solution, with the above structural form, the temperature of the locking mechanism can be detected in real time through the temperature detection member, and the safety of heating is ensured.

Preferably, the temperature detection member includes a grating sensor.

In this solution, with the above structural form, a grating sensor is characterized by high precision, thereby improving the detection accuracy.

A control method for an electric vehicle is provided, an electric vehicle is adopted, and the control method for the electric vehicle includes:
determining whether a first preset trigger condition is met, if so, starting the first heating portion and/or the second heating portion.

In this solution, with the above form, the battery pack is connected to the quick-swap bracket. With the above form, by determining whether a preset trigger condition is met, the quick-swap bracket can be heated by the first heating portion; and/or, the battery pack is heated by the second heating portion to prevent the quick-swap bracket and the battery pack from being frozen under extreme weather such as extreme freezing rain or heavy snow, such that the battery pack and the quick-swap bracket can be separated normally, the battery packs in cold regions can be quickly swapped normally, and the efficiency of quick swapping of battery packs in cold regions is improved. The above form avoids damage to the battery pack and the quick-swap bracket caused by forced battery swapping, and prolongs the service life of the battery pack and the quick-swap bracket. In addition, the above form improves the controllability of the first heating portion and/or the second heating portion, and avoids energy consumption caused by heating when the quick-swap bracket and the battery pack are not frozen.

Preferably, the step of determining whether the first preset trigger condition is met also includes: if not, continuing to detect the trigger condition.

In this solution, with the above form, when the first preset trigger condition is not met, the first heating portion and/or the second heating portion are not started, and energy consumption is reduced. When the first preset trigger condition is not met, the trigger condition continues to be detected, thereby achieving real-time detection of the trigger condition and improving the accuracy of starting the first heating portion and/or the second heating portion. In addition, with the above control solution, the first heating portion and/or the second heating portion can be started in specific weather or at a specific temperature, thereby clarifying the heating scenes of the first heating portion and/or the second heating portion.

Preferably, the first preset trigger condition includes at least one of a first preset weather and a first preset temperature.

In this solution, since weather and temperature have a great influence on whether the battery pack is frozen on the quick-swap bracket, therefore, the above form can be adopted to better prevent the battery pack and the quick-swap bracket from being frozen together, such that the battery packs can be quickly swapped normally, and the efficiency of quick swapping of battery packs in cold regions is improved.

Preferably, the determining whether the first preset trigger condition is met includes first determining whether the weather is the first preset weather condition, if so, then determining whether the temperature is lower than the first preset temperature, and if so, determining that the first preset trigger condition is met.

Preferably, the first preset weather condition includes rainy or snowy weather.

Preferably, the first preset temperature is minus 2 degrees Celsius.

Preferably, the electric vehicle includes a plurality of temperature detection members arranged corresponding to the locking mechanism and/or the locking member, to acquire the detection temperatures of the plurality of temperature detection members, and determine whether the detection temperature falls within a first preset temperature threshold. If so, the first heating portion and/or the second heating portion are started.

In this solution, the locking member on the battery pack cooperates with the locking mechanism on the quick-swap bracket, such that the battery pack is connected to the quick-swap bracket. With the above form, since the locking member is in direct contact with the locking mechanism, the detection temperature of the locking mechanism and/or the locking member is detected, and whether the first heating portion and/or the second heating portion are started is determined according to the detection temperature, thereby better preventing the battery pack and the quick-swap bracket from being frozen together, making the battery packs be quickly swapped normally, and improving the efficiency of quick swapping of battery packs in cold regions.

Preferably, the first heating portion and/or the second heating portion corresponding to the threshold falling within the first preset temperature in the first heating portion and/or the second heating portion are started.

In this solution, a plurality of first heating portions are connected to the quick-swap bracket, and a plurality of second heating portions are connected to the battery pack body. With the above form, only the first heating portion and/or the second heating portion that fall within the first preset temperature threshold are started, thereby reducing energy consumption and improving the heating accuracy.

Preferably, the control method includes:
determining whether a third preset trigger condition is met, and if so, reducing the operating power of the first heating portion and/or the second heating portion.

In this solution, with the above form, the operating power of the first heating portion and/or the second heating portion is controlled by determining whether the trigger condition meets the third preset trigger condition, thereby ensuring that when the vehicle arrives at a charging station, the ice between the battery pack and the quick-swap bracket is just completely melted, making the battery packs be quickly swapped normally, and improving the efficiency of quick swapping of battery packs in cold regions.

Preferably, the third preset trigger condition is determined based on the distance between the current vehicle and the charging station.

In this solution, the above form is adopted to ensure that when the vehicle arrives at the charging station, the ice between the battery pack and the quick-swap bracket is just completely melted, and energy consumption is reduced.

Preferably, the third preset trigger condition is determined based on the remaining power of the vehicle.

In this solution, when the remaining power of the vehicle is low, the heating power of the first heating portion and the second heating portion can be reduced, to ensure that the vehicle can drive to the destination normally. The above form can be adopted to prevent the battery pack and the quick-swap bracket from being frozen together, and the vehicle can also drive to the destination normally according to actual needs.

The third preset trigger condition is determined comprehensively based on the distance between the current vehicle and the charging station and the remaining power of the vehicle.

In this solution, the above form is adopted to ensure that when the vehicle arrives at the charging station, the ice between the battery pack and the quick-swap bracket is just completely melted, and energy consumption is reduced.

Preferably, the control method includes:
determining whether a fifth preset trigger condition is met, and if so, increasing the operating power of the first heating portion and/or the second heating portion.

In this solution, with the above form, the operating power of the first heating portion and/or the second heating portion is controlled by determining whether the trigger condition meets the fifth preset trigger condition, thereby ensuring that the current vehicle can reach the charging station with the remaining power, and further ensuring that the vehicle can drive normally.

Preferably, the fifth preset trigger condition is determined based on the distance between the current vehicle and the charging station.

In this solution, with the above form, the battery pack and the quick-swap bracket can be better prevented from being frozen together while ensuring that the vehicle can drive normally, such that the battery packs can be quickly swapped normally and the efficiency of quick swapping of battery packs in cold regions is improved.

Preferably, the fifth preset trigger condition is determined based on the remaining power of the vehicle.

In this solution, with the above form, the battery pack and the quick-swap bracket can be better prevented from being frozen together while ensuring that the vehicle can drive normally, such that the battery packs can be quickly swapped normally and the efficiency of quick swapping of battery packs in cold regions is improved.

Preferably, the fifth preset trigger condition is determined comprehensively based on the distance between the current vehicle and the charging station and the remaining power of the vehicle.

In this solution, with the above form, when the vehicle arrives at the charging station, the battery pack and the quick-swap bracket can be better prevented from being frozen together, such that the battery packs can be quickly swapped normally and the efficiency of quick swapping of battery packs in cold regions is improved.

The positive and progressive effects of the present disclosure are as follows:

The quick-swap bracket is heated by the first heating portion, and/or the battery pack is heated by the second heating portion, to prevent the quick-swap bracket and the battery pack from being frozen under extreme weather such as extreme freezing rain or heavy snow, such that the battery pack and the quick-swap bracket can be separated normally, the battery packs can be quickly swapped normally, and the efficiency of quick swapping of battery packs in cold regions is improved. In addition, the above structural form avoids damage to the battery pack and the quick-swap bracket caused by forced battery swapping, and prolongs the service life of the battery pack and the quick-swap bracket. By determining whether a preset trigger condition is met, the quick-swap bracket can be heated by the first heating portion; and/or the battery pack can be heated by the second heating portion, thereby improving the controllability of the first heating portion and/or the second heating portion, and avoiding energy consumption caused by heating when the battery pack and the quick-swap bracket are not frozen.

### BRIEF DESCRIPTION OF THE DRAWINGS

FIG. 1 is a first structural schematic diagram of a quick-swap device according to Embodiment 1 of the present disclosure;

FIG. 2 is a second structural schematic diagram of a quick-swap device according to Embodiment 1 of the present disclosure;

FIG. 3 is a third structural schematic diagram of a quick-swap device according to Embodiment 1 of the present disclosure;

FIG. 4 is a fourth structural schematic diagram of a quick-swap device according to Embodiment 1 of the present disclosure;

FIG. 5 is a fifth structural schematic diagram of a quick-swap device according to Embodiment 1 of the present disclosure;

FIG. 6 is a structural schematic diagram of a first portion of the quick-swap device according to Embodiment 1 of the present disclosure;

FIG. 7 is a structural schematic diagram of a second portion of the quick-swap device according to Embodiment 1 of the present disclosure;

FIG. 8 is a structural schematic diagram of a third portion of the quick-swap device according to Embodiment 1 of the present disclosure;

FIG. 9 is a structural schematic diagram of a fourth portion of the quick-swap device according to Embodiment 1 of the present disclosure;

FIG. 10 is a structural schematic diagram of a first portion of the electric vehicle according to Embodiment 1 of the present disclosure;

FIG. 11 is a structural schematic diagram of a second portion of the electric vehicle according to Embodiment 1 of the present disclosure;

FIG. 12 is a first structural schematic diagram of a quick-swap device according to Embodiment 3 of the present disclosure;

FIG. 13 is a second structural schematic diagram of a quick-swap device according to Embodiment 3 of the present disclosure;

FIG. 14 is a third structural schematic diagram of a quick-swap device according to Embodiment 3 of the present disclosure;

FIG. 15 is a fourth structural schematic diagram of a quick-swap device according to Embodiment 3 of the present disclosure;

FIG. 16 is a schematic diagram of a quick-swap device according to Embodiment 4 of the present disclosure;

FIG. 17 is a first structural schematic diagram of a first heating portion according to Embodiment 4 of the present disclosure;

FIG. 18 is a second structural schematic diagram of a first heating portion according to Embodiment 4 of the present disclosure;

FIG. 19 is a third structural schematic diagram of a first heating portion according to Embodiment 4 of the present disclosure;

FIG. 20 is a schematic diagram of a partial structural of a first heating portion according to Embodiment 4 of the present disclosure;

FIG. 21 is a first structural schematic diagram of a battery pack according to Embodiment 6 of the present disclosure;

FIG. 22 is a second structural schematic diagram of a battery pack according to Embodiment 6 of the present disclosure;

FIG. 23 is a third structural schematic diagram of a battery pack according to Embodiment 6 of the present disclosure;

FIG. 24 is a fourth structural schematic diagram of a battery pack according to Embodiment 6 of the present disclosure;

FIG. 25 is a fifth structural schematic diagram of a battery pack according to Embodiment 6 of the present disclosure;

FIG. 26 is a sixth structural schematic diagram of a battery pack according to Embodiment 6 of the present disclosure;

FIG. 27 is a seventh structural schematic diagram of a battery pack according to Embodiment 6 of the present disclosure;

FIG. 28 is an eighth structural schematic diagram of a battery pack according to Embodiment 6 of the present disclosure;

FIG. 29 is a ninth structural schematic diagram of a battery pack according to Embodiment 6 of the present disclosure;

FIG. 30 is a tenth structural schematic diagram of a battery pack according to Embodiment 6 of the present disclosure;

FIG. 31 is an eleventh structural schematic diagram of a battery pack according to Embodiment 6 of the present disclosure;

FIG. 32 is a first flow chart of a control method for an electric vehicle according to Embodiment 7 of the present disclosure;

FIG. 33 is a second flow chart of a control method for an electric vehicle according to Embodiment 7 of the present disclosure;

FIG. 34 is a third flow chart of a control method for an electric vehicle according to Embodiment 7 of the present disclosure;

FIG. 35 is a fourth flow chart of a control method for an electric vehicle according to Embodiment 7 of the present disclosure;

FIG. 36 is a structural schematic diagram of an electric vehicle according to Embodiment 7 of the present disclosure.

### REFERENCE NUMERALS IN THE FIGURES

### Embodiments 1-5

electric vehicle 1000, quick-swap device 100, quick-swap bracket 1, first bracket 11, first bending portion 111, first bracket body 112, first mounting surface 113, second bracket 12, lock base 13, locking mechanism 14, first heating portion 2, heating film 21, connection member 22, mounting hole 211, electric heating wire 23, battery pack 200.

### Embodiment 6

quick-swap device 100, quick-swap bracket 1, locking mechanism 14, battery pack 200, battery pack body 2001, side wall 20011, surrounding frame 2002, locking member 2003, locking shaft 20031, positioning member 2004, second heating portion 2, heating film 21, through hole 212, connection member 22, fixed member 23.

### Embodiment 7

electric vehicle 1000, quick-swap device 100, quick-swap bracket 1, locking mechanism 14, battery pack 200, locking member 2003.

### DETAILED DESCRIPTION OF THE EMBODIMENTS

A preferred embodiment is given below, and the present disclosure is described more clearly and completely in conjunction with the accompanying drawings.

### Embodiment 1

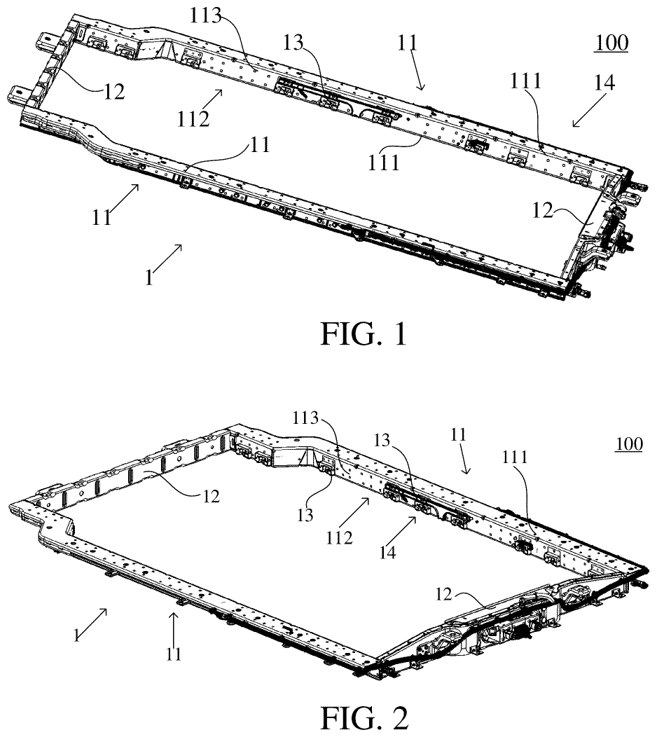

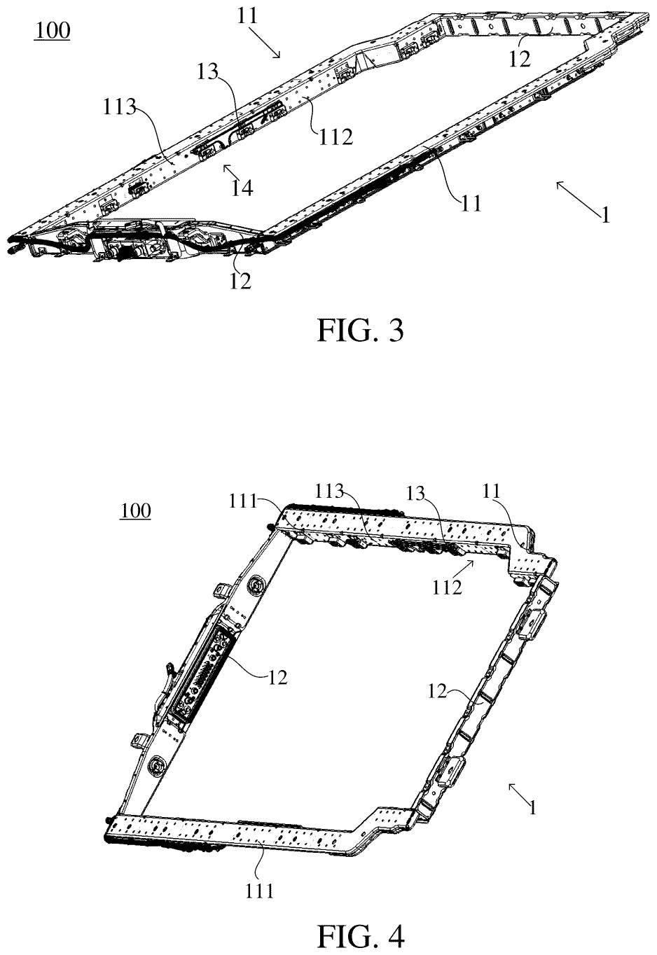

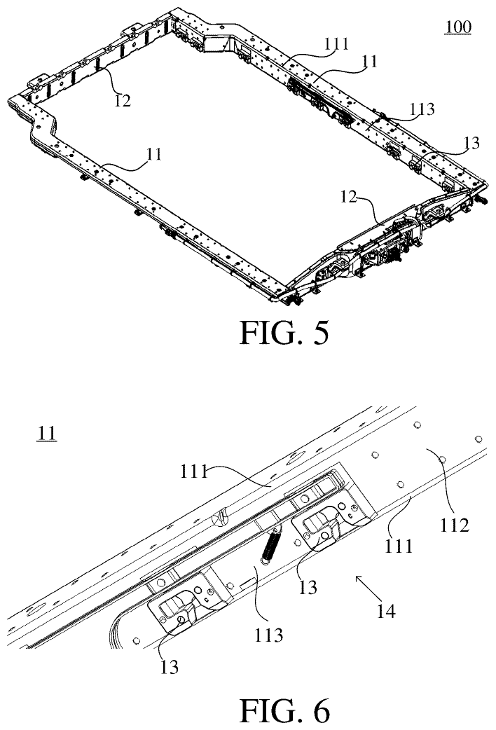

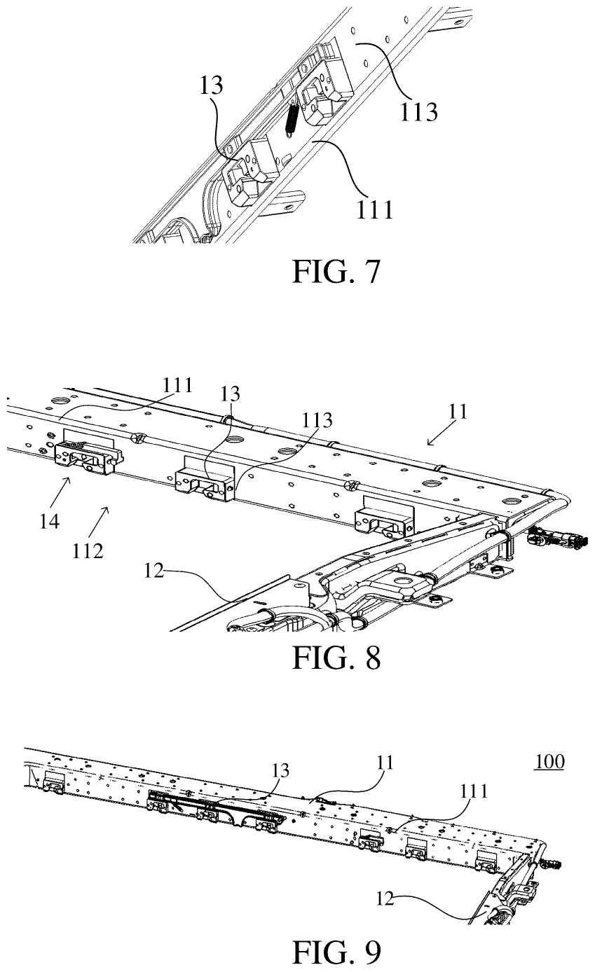

As shown in FIGS. 1 to 9, this embodiment provides a quick-swap device 100, and the quick-swap device 100 includes a quick-swap bracket 1 and a first heating portion 2, wherein the first heating portion 2 is connected to the quick-swap bracket 1 and is configured to heat the quick-swap bracket 1. Specifically, the battery pack 200 is connected to the quick-swap bracket 1. With the above structural form, the quick-swap bracket 1 is heated by the first heating portion 2, to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally, and the efficiency of quick swapping of the battery pack 200 in cold regions is improved. In addition, the above structural form avoids damage to the battery pack 200 and the quick-swap bracket 1 caused by forced battery swapping, and prolongs the service life of the battery pack 200 and the quick-swap bracket 1.

In this embodiment, the first heating portion 2 includes one or more of a electric heating wire 23, a heating film 21, a heating plate, a heating belt, an electric heating belt, and a heating tracing belt, and a suitable type of the first heating portion 2 can be selected according to actual needs.

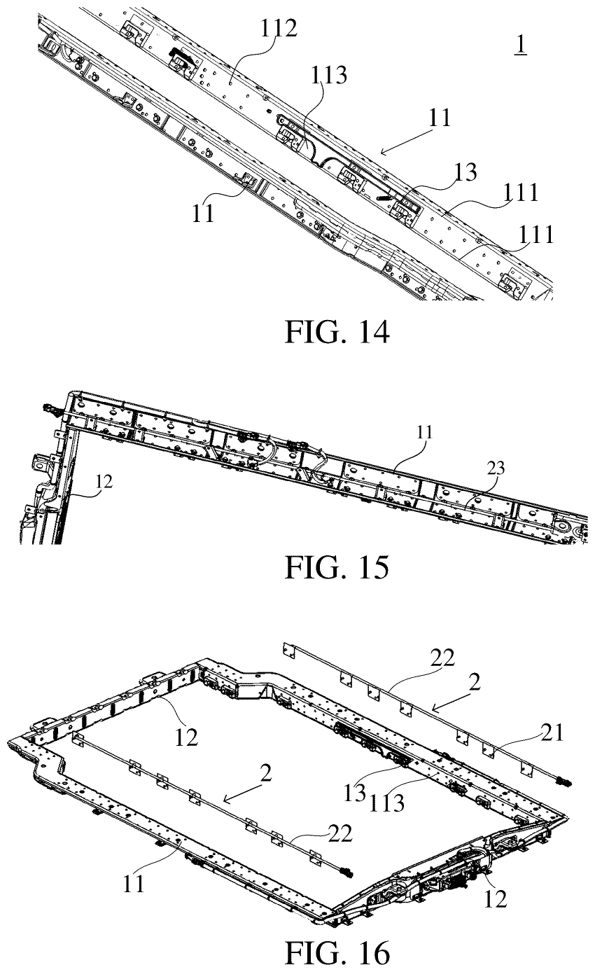

As shown in FIGS. 1 to 14, the quick-swap bracket 1 includes a first bracket 11 and a locking mechanism 14, wherein the locking mechanism 14 is arranged on the first bracket 11, the first heating portion 2 is at least arranged on the first bracket 11, and the first heating portion 2 is configured to heat at least the locking mechanism 14. Specifically, the battery pack 200 is connected to the locking mechanism 14 to achieve the connection between the battery pack 200 and the quick-swap bracket 1. In other words, the locking member on the battery pack 200 is connected to the locking mechanism 14 to achieve the connection between the battery pack 200 and the quick-swap bracket 1. Since the locking member on the battery pack 200 is directly connected with the locking mechanism 14, the first heating portion 2 is configured to heat at least the locking mechanism 14, thereby preventing failure in disassembling the battery pack 200 caused when the connection positions between the battery pack 200 and the locking mechanism 14 are frozen together, ensuring that the battery packs 200 in cold regions can be quickly swapped normally, and improving the efficiency of quick swapping of the battery packs 200 in cold regions. In addition, the above structural form avoids damage to the battery pack 200 and the first bracket 11 caused by forced battery swapping, and prolongs the service life of the battery pack 200 and the first bracket 11.

Please refer to FIGS. 1 to 8 for understanding. The first bracket 11 is provided with a first mounting surface 113 for mounting the locking mechanism 14, and the first heating portion 2 is at least arranged on the first mounting surface 113. Specifically, the first heating portion 2 is at least arranged on the first mounting surface 113, and the key-position locking mechanism 14 can be directly heated by the first heating portion 2, thereby preventing failure in disassembling the battery pack 200 caused when the connection positions between the battery pack 200 and the locking mechanism 14 are frozen together. The above structural form is adopted to improve the heating efficiency of the locking mechanism 14 by the first heating portion 2, such that the first heating portion 2 can consume lower energy to prevent the quick-swap bracket 1 and the battery pack 200 from being frozen.

In this embodiment, the first mounting surface 113 is located on a side of the first bracket 11 facing the battery pack 200. In other embodiments, the position of the first mounting surface 113 can be adjusted according to actual needs, and is not limited herein.

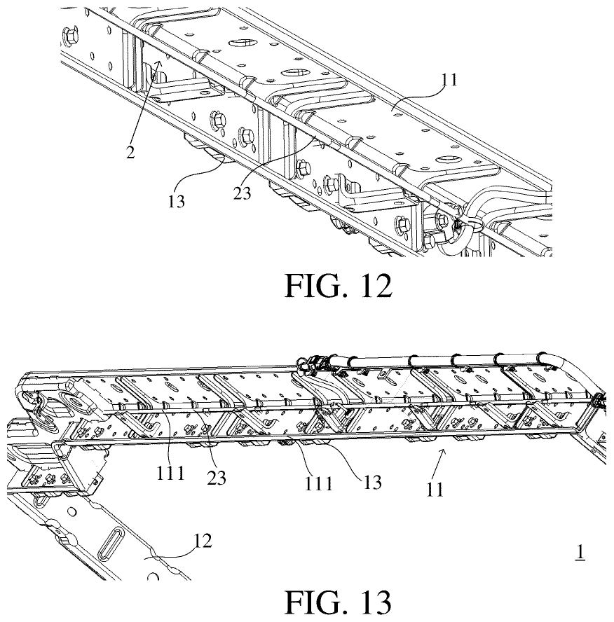

In other embodiments, as shown in FIGS. 12 and 13, the first heating portion 2 is at least arranged on the side of the quick-swap bracket 1 deviating from the first mounting surface 113. Specifically, the first heating portion 2 first heats the side of the quick-swap bracket 1 deviating from the first mounting surface 113, and transfers the heat to a first heating surface and then to the locking mechanism 14 through heat conduction, thereby heating the locking mechanism 14 by the first heating portion 2, and then preventing failure in disassembling the battery pack 200 caused when the connection positions between the battery pack 200 and the locking mechanism 14 are frozen together. The above structural form can be adopted to prevent interference between the first heating portion 2 and the locking mechanism 14, such that both the first heating portion 2 and the locking mechanism 14 can work normally, the battery pack 200 can be stably connected to the locking mechanism 14, and the stability and reliability of the connection of the battery pack 200 to the quick-swap bracket 1 are improved.

In this embodiment, the quick-swap bracket 1 is made of a thermally conductive material.

As shown in FIGS. 1 to 5, the quick-swap bracket 1 further includes a second bracket 12, the first bracket 11 and the second bracket 12 enclose a frame structure, and the first heating portion 2 is at least arranged on the second bracket 12. The second bracket 12 is configured to mount an electrical connector to achieve electrical connection with the battery pack, and the frame structure is configured to accommodate the battery pack 200, such that the battery pack 200 can be protected by the frame structure, and the service life of the battery pack 200 is prolonged. In addition, the above structural form can be adopted to prevent the second bracket 12 and the battery pack 200 from being frozen, such that the second bracket 12 and the battery pack 200 can be separated normally, and normal battery swapping can be achieved in cold regions.

The first heating portion 2 is arranged on the second bracket 12, and can be attached to the surface of the second bracket 12; the first heating portion 2 can also be wound around the second bracket 12 along the extension direction of the second bracket 12; and the first heating portion 2 can also be attached to the surface of the second bracket 12 and wound around the second bracket 12 along the extension direction of the second bracket 12. Preferably, the first heating portion 2 is not only attached to the surface of the second bracket 12, but also wound around the second bracket 12 along the extension direction of the second bracket 12. The above structural form is adopted to facilitate the heating of the second bracket 12 by the first heating portion 2 and improve the heating efficiency of the second bracket 12 by the first heating portion 2. The above structural form facilitates the arrangement of the first heating portion 2, such that the first heating portion 2 is fixedly more firmly, the contact area between the first heating portion 2 and the second bracket 12 is increased, and the heating efficiency of the first heating portion 2 is improved.

In this embodiment, the second bracket 12 is made of a thermally conductive material.

In other embodiments, the first heating portion 2 is arranged on the first bracket 11 and the second bracket 12, and the first heating portion 2 is wound along extension directions of the first bracket 11 and the second bracket 12. The above structural form is adopted to further facilitate the arrangement of the first heating portion 2, such that the first heating portion 2 is fixed more firmly, the contact area between the first heating portion 2 and the quick-swap bracket 1 is increased, and the heating efficiency of the first heating portion 2 is further improved.

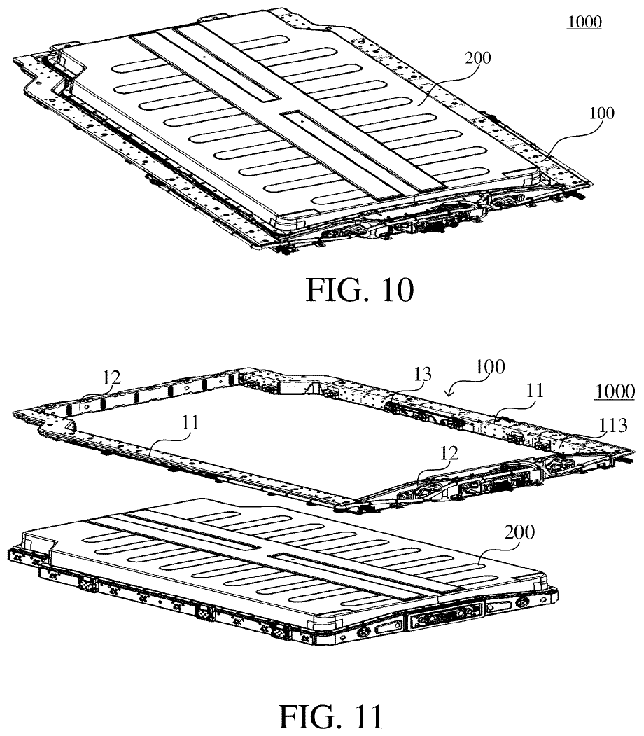

As shown in FIGS. 10 and 11, this embodiment further provides an electric vehicle 1000, and the electric vehicle 1000 includes a quick-swap device 100. Specifically, the quick-swap device 100 is applied to the electric vehicle 1000, and the battery pack 200 can be connected to the quick-swap bracket 1, such that the battery pack 200 is connected to the electric vehicle 1000. With the above structural form, the quick-swap bracket 1 is heated by the first heating portion 2, to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally, and the efficiency of quick swapping of battery packs 200 in cold regions is improved. In addition, the above structural form avoids damage to the battery pack 200 and the quick-swap bracket 1 caused by forced battery swapping, and prolongs the service life of the battery pack 200 and the quick-swap bracket 1.

In this embodiment, the quick-swap bracket 1 is a body frame of the electric vehicle 1000 or the quick-swap bracket 1 is arranged on the body frame.

The first heating portion 2 is electrically connected to the vehicle power distribution box or the battery pack 200. With the above structure, the first heating portion 2 can be powered by the vehicle power distribution box or the battery pack 200, thereby ensuring that the first heating portion 2 can normally heat the quick-swap bracket 1, preventing the battery pack 200 and the quick-swap bracket 1 from being frozen, and ensuring normal battery swapping in cold regions.

In this embodiment, the first heating portion 2 is electrically connected to the vehicle power distribution box. In order to improve the safety of use, the first heating portion 2 preferably uses low-voltage electricity.

In other embodiments, a battery can be arranged on the quick-swap bracket 1, and the battery is electrically connected to the battery pack 200 and the first heating portion 2, respectively, such that the battery pack 200 can charge the battery and store the power in the battery, and when the first heating portion 2 needs to be powered, the battery directly supplies power to the first heating portion 2.

The electric vehicle 1000 further includes a temperature detection portion, and the temperature detection portion is configured to detect the temperature of the quick-swap device 100, such that the temperature of the quick-swap device 100 can be detected in real time through the temperature detection portion, and the safety of heating is ensured.

The temperature detection portion includes a plurality of temperature detection members, and the plurality of temperature detection members are arranged corresponding to the locking mechanism 14. With the above structural form, the temperature of the locking mechanism 14 can be detected in real time by the temperature detection member, and the safety of heating is ensured. Preferably, the plurality of temperature detection members are in one-to-one correspondence with the plurality of locking mechanisms 14, such that each locking mechanism 14 is provided with a temperature detection member to detect its temperature.

In this embodiment, the temperature detection member includes a grating sensor, and the grating sensor is characterized by high precision, thereby improving the detection accuracy.

During specific implementation, for the first heating portion 2, the present disclosure provides some feasible embodiments as follows in the following content, but the protection scope of the present disclosure should not be limited to the following embodiments.

### Embodiment 2

The first heating portion 2 is wound around the first bracket 11 along the extension direction of the first bracket 11. The above structure is adopted to facilitate the arrangement of the first heating portion 2, such that the first heating portion 2 is fixedly more firmly, the contact area between the first heating portion 2 and the first bracket 11 is increased, and the heating efficiency of the first heating portion 2 is improved. In order to further increase the contact area between the first heating portion 2 and the first bracket 11 and improve the heating efficiency of the first heating portion 2, the first heating portion 2 is preferably spirally wound or directly wound around the first bracket 11 along the extension direction.

Since the first bracket 11 includes the first bracket body 112 and the first bending portion 111, the first bending portion 111 is bent from the first bracket body 112 towards the direction away from the locking mechanism 14, such that the cross section of the first bracket 11 is L-shaped. When the first heating portion 2 is wound around the first bracket body 112 and the first bending portion 111 in sequence, the cross section wound by the first heating portion 2 is triangular.

As shown in FIGS. 1 to 13, the locking mechanism 14 includes a plurality of lock bases 13, and the extension direction of the first heating portion 2 is the same as the distribution directions of the plurality of lock bases 13. Specifically, the plurality of lock bases 13 are arranged on the first mounting surface 113 and are arranged at intervals along the extension direction of the first bracket 11. The locking member on the battery pack 200 cooperates with the lock base 13, such that the battery pack 200 is connected to the first bracket 11, and since a plurality of lock bases 13 are arranged, the stability and reliability of the connection of the battery pack 200 are improved. The first heating portion 2 heats the plurality of lock bases 13, such that the first heating portion 2 heats the first bracket 11 more evenly, the gap between the lock base 13 and the battery pack 200 and the gap between the battery pack 200 and the first bracket 11 can be prevented from being frozen, and the battery pack 200 and the first bracket 11 can be separated normally, thereby ensuring that the battery packs 200 in cold regions can be quickly swapped normally, and improving the efficiency of quick swapping of battery packs 200 in cold regions.

The first heating portion 2 includes a first heating member, and the first heating member is arranged at a corresponding position of the lock base 13 and is configured to heat the lock base 13. The above structural form is adopted to improve the heat conduction efficiency of the first heating portion 2, thereby preventing the lock base 13 and the locking member on the battery pack 200 from being frozen together, ensuring that the battery pack 200 in cold regions can be swapped normally, and improving the efficiency of quick swapping of the battery packs 200.

The first heating member can be attached to the surface of the first bracket 11 connected to the lock base 13, can also be wound around the first bracket 11 along the distribution direction of the lock base 13, can also be attached to the surface of the first bracket 11 connected to the lock base 13, and is wound around the first bracket 11 along the distribution direction of the lock base 13. Preferably, the first heating member is attached to the surface of the first bracket 11 connected to the lock base 13, and is wound around the first bracket 11 along the distribution direction of the lock base 13. The above structural form is adopted to enhance the heating of the key-position lock base 13 by the first heating portion 2, and compared with other arrangements, the first heating portion 2 can consume lower energy to prevent the first bracket 11 and the battery pack 200 from being frozen. The first heating portion 2 is wound around the first bracket 11 along the distribution direction of the lock base 13, and a reliable and effective heating member arrangement solution is provided to facilitate the mounting of the first heating member, such that the first heating member is fixed more firmly, the contact area between the first heating portion 2 and the first bracket 11 is increased, and the heating efficiency of the first heating portion 2 is improved.

The widths of the first heating portion 2 along the extension direction of the first bracket 11 are different. With the above structural form, the area of the first heating portion 2 can be increased in the regions prone to icing and freezing, thereby improving the heating efficiency of the first heating portion 2 in the freezing region, and then ensuring uniform heating of the quick-swap bracket 1. The first heating portion 2 is characterized by saving heating materials and good economy. Preferably, the width of the first heating portion 2 close to the locking mechanism 14 is greater than the widths of other regions, thereby increasing the contact area between the first heating portion 2 and the locking mechanism 14, improving the heating effect of the locking mechanism 14 by the first heating portion 2. Further, the locking mechanism 14 and the battery pack 200 can be prevented from being frozen, thereby ensuring that the battery packs 200 in cold regions can be quickly swapped normally, and improving the efficiency of swapping of battery packs 200. Preferably, a heating belt with a variable cross section can be uniformly heated by a heating belt, with characteristics of convenient setting and cost saving.

### Embodiment 3

As shown in FIGS. 12 to 15, the first bracket 11 includes a first bracket body 112 and at least one first bending portion 111, the locking mechanism 14 is arranged on the first bracket body 112, the first bending portion 111 is bent from the first bracket body 112 to a direction away from the locking mechanism 14, the first bending portion 111 extends along the length direction of the first bracket 11, and the first heating portion 2 is arranged at the junction of the first bending portion 111 and the first bracket body 112. With the above structural form, the first heating portion 2 is protected by the first bending portion 111, and the service life of the first heating portion 2 is prolonged. In addition, the first bending portion 111 is arranged to enhance the structural strength of the first bracket 11 and prolong the service life of the first bracket 11.

The first heating portion 2 includes electric heating wires 23, a plurality of electric heating wires 23 are arranged, and the plurality of electric heating wires 23 are arranged in parallel at the junction between each first bending portion 111 and the first bracket body 112. The above structural form is adopted to facilitate the arrangement of the electric heating wires 23. In addition, since the electric heating wires 23 can be compressed and bent, the electric heating wires 23 can be effectively attached to the surface of the first bracket 11, thereby increasing the heating area of the first bracket 11 and improving the heating efficiency of the first heating portion 2 on the first bracket 11.

In this embodiment, two first bending portions 111 are arranged, and the two first bending portions 111 are respectively located at the top and the bottom of the first bracket body 112. Correspondingly, two electric heating wires 23 are arranged, and the two electric heating wires 23 are respectively arranged in parallel at the junction between the two first bending portions 111 and the first bracket body 112. In other embodiments, the number of the first bending portions 111 and the number of the electric heating wires 23 can be adjusted according to actual needs and are not limited herein.

During specific use, the electric heating wire 23 is arranged on a side of the first bracket body 112 deviating from the locking mechanism 14. The above structural form can be adopted to prevent interference between the electric heating wire 23 and the locking mechanism 14, such that both the electric heating wire 23 and the locking mechanism 14 can work normally, the battery pack 200 can be stably connected to the locking mechanism 14, and the stability and reliability of the connection of the battery pack 200 to the bracket body are improved.

### Embodiment 4

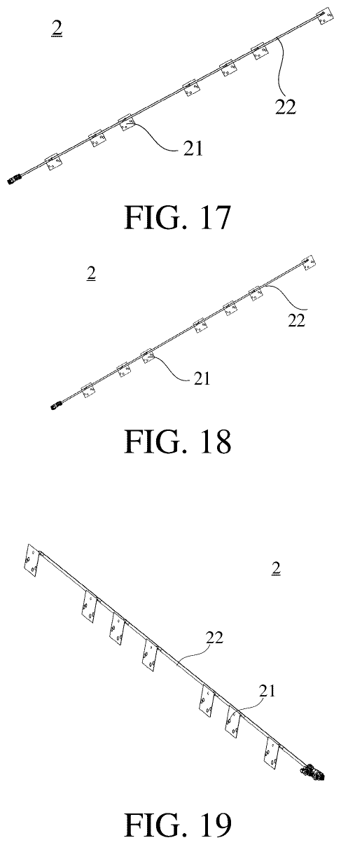

As shown in FIGS. 16 to 20, the first heating portion 2 includes a plurality of heating films 21, the heating films 21 are connected to the surface of the first bracket 11, and the distribution of the plurality of heating films 21 corresponds to the distribution of the plurality of locking mechanisms 14. With the above structural form, the heating film 21 can heat the plurality of locking mechanisms 14, such that the heating film 21 heats the first bracket 11 more evenly, and the gap between each locking mechanism 14 and the battery pack 200 and the gap between the battery pack 200 and the first bracket 11 can be prevented from being frozen, the battery pack 200 and the first bracket 11 can be separated normally, and the efficiency of quick swapping of battery packs 200 in cold regions can be improved. Specifically, the heating film 21 can be arranged on the first bracket 11 piece by piece, such that the heating film 21 can be arranged on the plane of the first bracket 11 to increase the contact area between the heating film 21 and the first bracket 11, and the heating efficiency of the heating film 21 is improved. Preferably, the plurality of heating films 21 on the same side are connected in series, and the heating efficiency of the heating film 21 is further improved.

In this embodiment, the heating film 21 is formed with a mounting hole 211 that can correspond to the hole of the locking mechanism 14, and the mounting hole 211 and the hole on the locking mechanism 14 are connected by a connection member 22, such that the heating film 21 is connected to the first bracket 11. In other embodiments, the heating film 21 can be bonded to the first bracket 11 by structural adhesive.

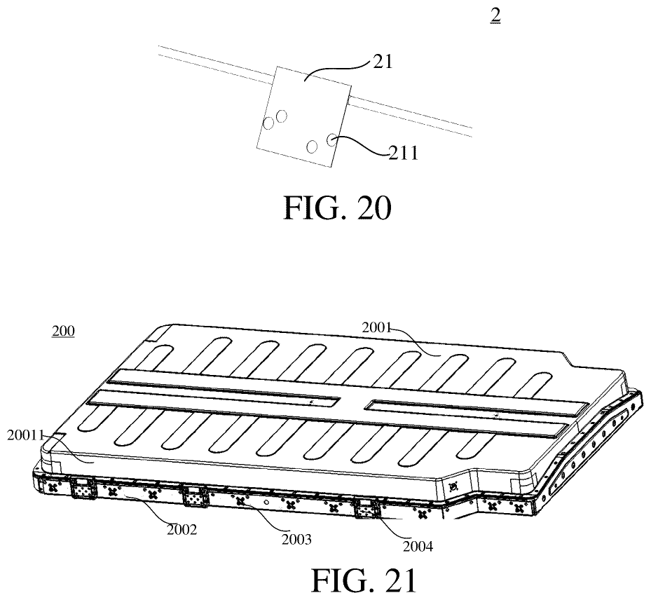

As shown in FIG. 20, in order to improve the connection stability of the heating film 21, a plurality of mounting holes 211 are preferably arranged.

The first heating portion 2 further includes a connection member 22, and the plurality of heating films 21 are electrically connected through the connection member 22. With the above structural form, the plurality of heating films 21 are connected through the connection member 22, to improve the stability of the connection between the heating film 21 and the first bracket 11, and the plurality of heating films 21 are connected to the power supply through the first connection member 22, thereby simplifying the heating structure and ensuring the heating efficiency.

In this embodiment, the extension direction of the connection member 22 is the same as the distribution direction of the heating film 21, thereby facilitating the electrical connection between the heating film 21 and the connection member 22. Preferably, the connection member 22 is located on a side of the first bracket 11 deviating from the locking mechanism 14. With the above structural form, the space for mounting the locking mechanism 14 on the first bracket 11 cannot be occupied, and interference between the connection member 22 and the locking mechanism 14 can be prevented, such that both the connection member 22 and the locking mechanism 14 can work normally, and the battery pack 200 can be stably connected to the locking mechanism 14.

### Embodiment 5

The first heating portion 2 further includes a PTC plate, the PTC plate is connected to the first bracket 11, and the distribution direction of the PTC plate is the same as the extension direction of the first bracket 11. With the above structural form, the first bracket 11 is heated by the PTC plate, to prevent failure in swapping the battery pack 200 caused when the lock base 13 and the battery pack 200 are frozen. The distribution direction of the PTC plate is the same as the extension direction of the first bracket 11, to ensure the uniformity of the heating of the PTC plate on the first bracket 11.

### Embodiment 6

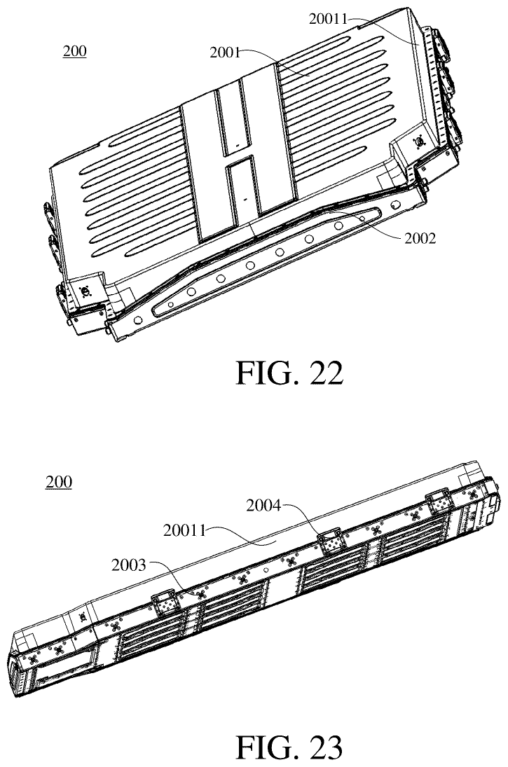

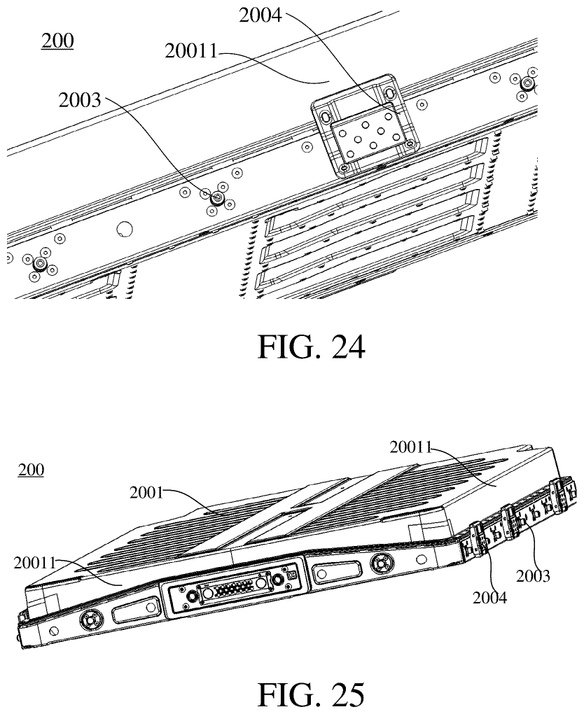

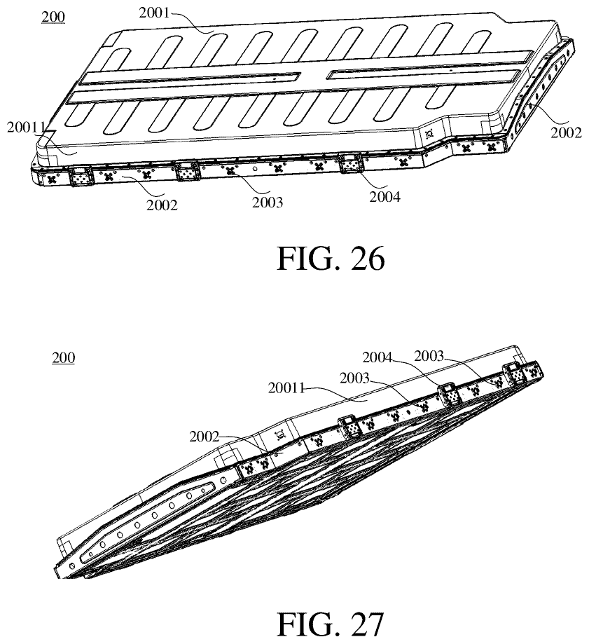

As shown in FIGS. 21 to 31, the present disclosure provides a battery pack 200, the battery pack 200 includes a second heating portion 2, and the second heating portion 2 is configured to heat the battery pack 200. Specifically, the battery pack 200 is connected to the quick-swap bracket 1. With the above structural form, the battery pack 200 is heated by the second heating portion 2, to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally, and the efficiency of quick swapping of battery packs 200 in cold regions is improved. In addition, the above structural form avoids damage to the battery pack 200 and the quick-swap bracket 1 caused by forced battery swapping, and prolongs the service life of the battery pack 200 and the quick-swap bracket 1.

In this embodiment, the second heating portion 2 is in the form of a heating film 21. In other embodiments, the second heating portion 2 can also be one or more of a heating wire, a heating plate, a heating belt, an electric heating belt, and a heating tracing belt, and a suitable type of the second heating portion 2 can be selected according to actual needs.

As shown in FIGS. 21 to 27, the battery pack 200 includes a battery pack body 2001, and the second heating portion 2 is connected to the battery pack body 2001. The battery pack body 2001 includes a battery pack case 20012, and a battery cell arranged in the battery pack case 20012. The battery pack case 20012 includes two side walls 20011 arranged in the width direction of the battery pack case 20012 for setting the locking member 2003 of the battery pack 200. The battery pack case 20012 also includes two side walls 20011 arranged in the length direction of the battery pack case 20012 for setting an electrical connector of the battery pack 200. Specifically, the battery pack body 2001 is connected to the quick-swap bracket 1. With the above structural form, the battery pack body 2001 is heated by the second heating portion 2, to prevent the quick-swap bracket 1 and the battery pack body 2001 from being frozen under extreme weather such as extreme freezing rain or heavy snow, such that the battery pack body 2001 and the quick-swap bracket 1 can be separated normally, the battery pack body 2001 can be quickly swapped normally, and the efficiency of quick swapping of the battery pack 200 in cold regions is improved. In addition, the above structural form avoids damage to the battery pack body 2001 and the quick-swap bracket 1 caused by forced battery swapping, and prolongs the service life of the battery pack body 2001 and the quick-swap bracket 1.

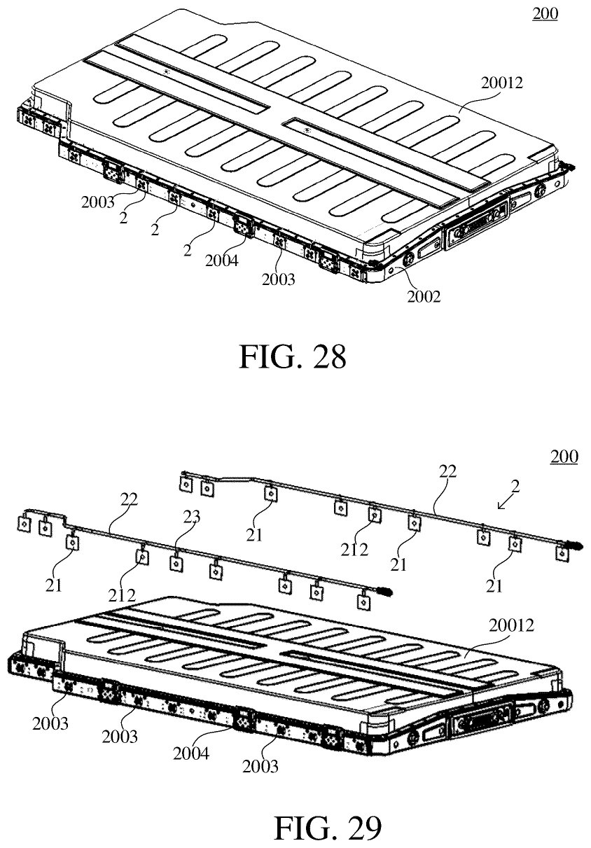

As shown in FIGS. 28 to 31, the battery pack 200 includes a locking member 2003, the locking member 2003 is arranged on the battery pack body 2001, and the second heating portion 2 and the locking member 2003 are connected to the same side of the battery pack body 2001. Specifically, the second heating portion 2 is arranged on the side wall 20011 of the exposed battery pack case 20012, and the locking member 2003 is connected to the locking mechanism 14 on the quick-swap bracket 1 to achieve connection between the battery pack 200 and the quick-swap bracket 1. The second heating portion 2 and the locking member 2003 are connected to the same side of the battery pack body 2001, thereby preventing failure in quick swapping of the battery pack 200 when the connection positions between the locking member 2003 and the locking mechanism 14 are frozen together, and ensuring that the battery packs 200 in cold regions can be quickly swapped normally. The above structural form is adopted to improve the heating efficiency of the second heating portion 2 on the locking member 2003 and improve the efficiency of quick swapping of the battery pack 200 in cold regions. In addition, the above structural form avoids damage to the battery pack 200 and the quick-swap bracket 1 caused by forced battery swapping, and prolongs the service life of the battery pack 200 and the quick-swap bracket 1.

In this embodiment, please refer to FIGS. 29 to 31 for understanding, the second heating portion 2 includes heating films 21 and a connection member 22, a plurality of heating films 21 are electrically connected through the connection member 22, and the plurality of heating films 21 located on the same side are connected in series. In order to facilitate the connection between the heating film 21 and the connection member 22, each heating film 21 is preferably electrically connected to the connection member 22 through a fixed member 23.

The locking member 2003 includes a mounting seat, a locking shaft 20031 and a supporting shaft, wherein the locking shaft 20031 and the supporting shaft are arranged on two opposite sides of the mounting seat, and the mounting seat is configured to be mounted on the side wall 20011 of the battery pack case 20012. The supporting shaft is configured to be inserted into the battery pack case 20012 and act on the battery pack case 20012, and one end of the locking shaft 20031 is connected to the mounting seat, and the other end of the locking shaft 20031 extends in a direction close to the locking mechanism 14, and is configured to cooperate with the locking mechanism 14 on the quick-swap bracket 1. During specific use, a through hole 212 is formed on the heating film 21, and the through hole 212 is configured to be sleeved on the locking member 2003. The heating film 21 is sleeved on the locking shaft 20031 through the through hole 212, and the heating film 21 is attached to the side wall 20011 of the exposed battery pack case 20012, such that the heating film 21 can directly heat the locking shaft 20031, and the heating efficiency of the heating film 21 on the locking shaft 20031 is improved.

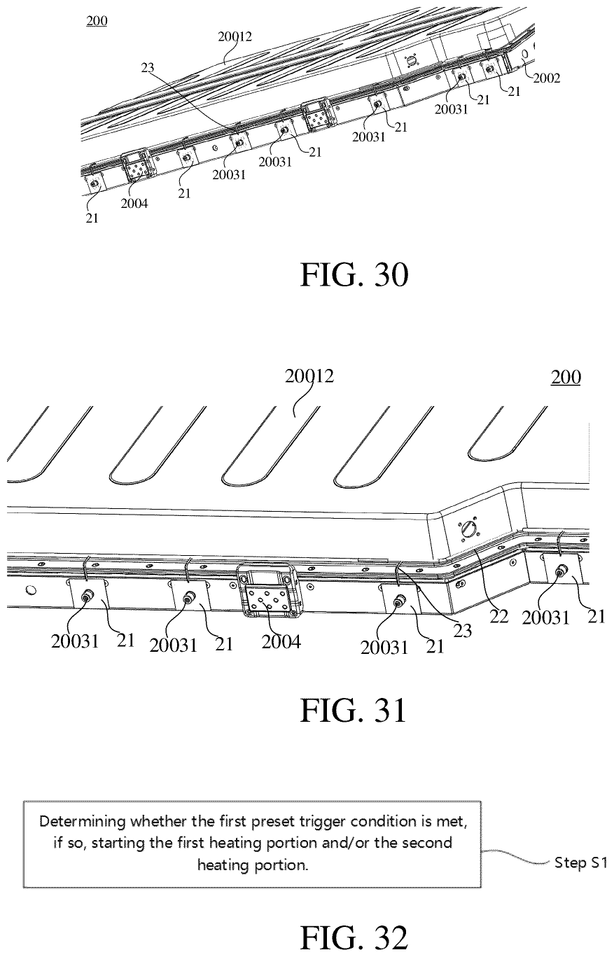

Specifically, as shown in FIGS. 30 and 31, the side wall 20011 of the battery pack case 20012 is stepped. In order to enhance the stability and reliability of the connection between the second heating portion 2 and the side wall 20011, the fixed member 23 is preferably clamped on the step, and the connection member 22 is attached to the upper surface of the step.

During specific use, a plurality of locking members 2003 are arranged, and the plurality of locking members 2003 are arranged at intervals around the battery pack case 20012, thereby improving the stability of the connection between the battery pack body 2001 and the quick-swap bracket 1. Specifically, one end of the locking member 2003 is connected to the side wall 20011 of the battery pack body 2001, and the other end of the locking member 2003 extends towards a direction close to the locking mechanism 14, thereby facilitating the cooperation between the locking member 2003 and the locking mechanism 14, and achieving the connection of the battery pack 200 to the quick-swap bracket 1.

In other embodiments, a gap may also be formed between the second heating portion 2 and the locking member 2003. In other words, the second heating portion 2 may be arranged between two adjacent locking members 2003, and heat generated by the second heating portion 2 can be transferred to each locking member 2003 through heat conduction, thereby heating the locking member 2003 by the second heating portion 2, and preventing failure in quick swapping of the battery pack 200 caused when the connection positions between the locking member 2003 and the locking mechanism 14 on the quick-swap bracket 1 are frozen together. The above structural form can be adopted to prevent interference between the second heating portion 2 and the locking member 2003, such that both the second heating portion 2 and the locking member 2003 can work normally, the battery pack body 2001 can be stably connected to the locking mechanism 14, and the stability and reliability of the connection of the battery pack 200 to the quick-swap bracket 1 are enhanced. The second heating portion 2 can be connected to the side wall 20011 of the battery pack case 20012 through an external fixed mechanism.

During specific use, the gap between the second heating portion 2 and the locking member 2003 can be set according to actual needs, and the specific value of the gap is not limited herein.

In other embodiments, the battery pack 200 further includes a positioning member 2004 spaced apart from the locking member 2003, and a gap is formed between the second heating portion 2 and the positioning member 2004. The heat generated by the second heating portion 2 can be transferred to the positioning member 2004 through heat conduction, to prevent the positioning member 2004 and the quick-swap bracket 1 from being frozen, and prevent interference between the second heating portion 2 and the positioning member 2004, such that the positioning member 2004 can play a guiding role normally in the mounting process of the quick-swap battery pack 200, the quick-swap battery pack 200 can be aligned accurately with the vehicle body, and the mounting accuracy of the quick-swap battery pack 200 is improved.

Specifically, a plurality of positioning members 2004 are arranged at intervals on the two side walls 20011 along the length direction of the battery pack body 2001 to clamp the quick-swap battery pack 200 on the vehicle body. The positioning members 2004 play a guiding role in the mounting process of the quick-swap battery pack 200, and the quick-swap battery pack 200 can be aligned accurately with the vehicle body, such that the mounting accuracy of the quick-swap battery pack 200 is higher, and after the quick-swap battery pack 200 is mounted, the quick-swap battery pack 200 abuts against the quick-swap bracket 1 on the electric vehicle 1000 to limit the shaking of the battery pack 200 and ensure stable and reliable locking. At the same time, after the quick-swap battery pack 200 is mounted, the two sides of the quick-swap battery pack 200 abut against the vehicle body through a plurality of positioning members 2004, such that the two sides of the quick-swap battery pack 200 have a certain force on the vehicle body in the width direction, the shaking of the quick-swap battery pack 200 is effectively reduced, and the service life of the quick-swap battery pack 200 is prolonged.

During specific use, the gap between the second heating portion 2 and the positioning member 2004 can be set according to actual needs, and the specific value of the gap is not limited herein.

In other embodiments, the battery pack 200 includes a surrounding frame 2002 and a battery pack body 2001, wherein the surrounding frame 2002 is circumferentially arranged around the battery pack body 2001, the surrounding frame 2002 is provided with an accommodation cavity, and the second heating portion 2 is arranged in the accommodation cavity. With the above structural form, the surrounding frame 2002 is circumferentially arranged around the battery pack body 2001, and the battery pack body 2001 can be protected by the surrounding frame 2002, to prevent damage to the battery pack body 2001 caused when external objects collide with the battery pack body 2001, and prolong the service life of the battery pack body 2001. In addition, the second heating portion 2 is arranged in the accommodation cavity, and the second heating portion 2 can also be protected by the surrounding frame 2002, to prevent damage to the second heating portion 2 caused when external objects collide with the second heating portion 2, and prolong the service life of the second heating portion 2.

The surrounding frame 2002 is made of a profile, and the second heating portion 2 can be arranged in the profile cavity, and can be fixed through gluing or other mechanical fixing mechanisms.

During specific use, the surrounding frame 2002 and the battery pack body 2001 are detachably connected, such that if the surrounding frame 2002 or the battery pack body 2001 is damaged, only the damaged surrounding frame 2002 and the battery pack body 2001 need to be replaced for normal use, thereby reducing the usage cost. In addition, the above structural form facilitates the processing of the battery pack 200.

In other embodiments, the locking member 2003 is arranged on a side of the surrounding frame 2002 away from the battery pack body 2001, and the second heating portion 2 is arranged on a side of the accommodation cavity close to the locking member 2003. That is, one end of the locking member 2003 is connected to the surrounding frame 2002, and the other end is located on an outer side of the surrounding frame 2002, while the second heating portion 2 is located in the accommodation cavity in the surrounding frame 2002. The above structural form is adopted to improve the heat conduction efficiency of the second heating portion 2, thereby preventing the locking mechanism 14 on the quick-swap bracket 1 and the locking member 2003 from being frozen together, ensuring that the battery packs 200 in cold regions can be quickly swapped normally, and improving the efficiency of quick swapping of battery packs 200.

The second heating portion 2 can be attached to the battery pack body 2001 or the surrounding frame 2002; the second heating portion 2 can also be wound around the locking member 2003; and the second heating portion 2 can also be attached to the battery pack body 2001 or the surrounding frame 2002, and can also be wound around the locking member 2003. Preferably, the second heating portion 2 is not only attached to the battery pack body 2001 or the surrounding frame 2002, but also wound around the locking member 2003. The above structural form is adopted to facilitate the heating of the battery pack body 2001 or the surrounding frame 2002 by the second heating portion 2, facilitate the heating of the locking member 2003 by the second heating portion 2, and improve the heating efficiency of the battery pack body 2001 or the surrounding frame 2002 by the second heating portion 2; in addition, the above structural form facilitates the arrangement of the second heating portion 2, such that the second heating portion 2 is fixedly more firmly, the contact area between the second heating portion 2 and the locking member 2003 is increased, and the heating efficiency of the second heating portion 2 is improved.

As shown in FIGS. 10 and 11, this embodiment further provides an electric vehicle 1000, and the electric vehicle 1000 includes a quick-swap bracket 1 and a battery pack 200. Specifically, the battery pack 200 is applied to the electric vehicle 1000, and the battery pack 200 can be connected to the quick-swap bracket 1. With the above structural form, the battery pack 200 is heated by the second heating portion 2, to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally, and the efficiency of quick swapping of battery packs 200 in cold regions is improved. In addition, the above structural form avoids damage to the battery pack 200 and the quick-swap bracket 1 caused by forced battery swapping, and prolongs the service life of the battery pack 200 and the quick-swap bracket 1.

In this embodiment, the quick-swap bracket 1 is a body frame of the electric vehicle 1000 or the quick-swap bracket 1 is arranged on the body frame.

The second heating portion 2 is electrically connected to the vehicle power distribution box or the battery pack 200. With the above structural form, the second heating portion 2 can be powered by the vehicle power distribution box or the battery pack 200, thereby ensuring that the second heating portion 2 can normally heat the quick-swap bracket 1, preventing the battery pack 200 and the quick-swap bracket 1 from being frozen, and ensuring normal battery swapping in cold regions.

In this embodiment, the second heating portion 2 is electrically connected to the vehicle power distribution box. In order to improve the safety of use, the second heating portion 2 preferably uses low-voltage electricity.

In other embodiments, a battery can be arranged on the quick-swap bracket 1, and the battery is electrically connected to the battery pack 200 and the second heating portion 2, respectively, such that the battery pack 200 can charge the battery and store the power in the battery, and when the second heating portion 2 needs to be powered, the battery directly supplies power to the second heating portion 2.

In other embodiments, the electric vehicle 1000 further includes a temperature detection portion, and the temperature detection portion is configured to detect the temperature of the battery pack 200, such that the temperature of the quick-swap device 100 can be detected in real time through the temperature detection portion, and the safety of heating is ensured.

The temperature detection portion includes a plurality of temperature detection members, and the plurality of temperature detection members are arranged corresponding to the locking member 2003. With the above structural form, the temperature of the locking member 2003 can be detected in real time by the temperature detection member, and the safety of heating is ensured. Preferably, the plurality of temperature detection members are in one-to-one correspondence with the plurality of locking members 2003, such that each locking mechanism 14 is provided with a temperature detection member to detect its temperature.

In this embodiment, the temperature detection member includes a grating sensor, and the grating sensor is characterized by high precision, thereby improving the detection accuracy.

### Embodiment 7

As shown in FIGS. 32 and 35, this embodiment provides a control method for an electric vehicle 1000, the control method is applied to the electric vehicle 1000, and the electric vehicle 1000 includes a quick-swap device 100 and a battery pack 200. The quick-swap device 100 and the battery pack 200 can have the following implementation manners. In the first implementation manner, the quick-swap device 100 includes a quick-swap bracket 1 and a first heating portion, wherein the first heating portion is connected to the quick-swap bracket 1 and is configured to heat the quick-swap bracket 1; in the second implementation manner, the battery pack 200 includes a second heating portion, and the second heating portion is configured to heat the battery pack 200; in the third implementation manner, the quick-swap device 100 includes a quick-swap bracket 1 and a first heating portion, the first heating portion is connected to the quick-swap bracket 1 and is configured to heat the quick-swap bracket 1, and the battery pack 200 includes a second heating portion, and the second heating portion is configured to heat the battery pack 200. Preferably, the quick-swap device 100 includes a quick-swap bracket 1 and a first heating portion, the first heating portion is connected to the quick-swap bracket 1 and is configured to heat the quick-swap bracket 1, and the battery pack 200 includes a second heating portion, the second heating portion is configured to heat the battery pack 200, and the control method for the electric vehicle 1000 includes:

Step S1: determining whether a first preset trigger condition is met, if so, starting the first heating portion and the second heating portion. Specifically, the battery pack 200 is connected to the quick-swap bracket 1. With the above form, by determining whether a preset trigger condition is met, the quick-swap bracket 1 can be heated by the first heating portion; and the battery pack 200 can be heated by the second heating portion to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally in cold regions, and the efficiency of quick swapping of battery packs 200 in cold regions is improved. The above form avoids damage to the battery pack 200 and the quick-swap bracket 1 caused by forced battery swapping, and prolongs the service life of the battery pack 200 and the quick-swap bracket 1. In addition, the above form improves the controllability of the first heating portion and the second heating portion, and avoids energy consumption caused by heating when the quick-swap bracket 1 and the battery pack 200 are not frozen.

During specific use, the quick-swap bracket 1 includes a first bracket and a locking mechanism 14, wherein the locking mechanism 14 is arranged on the first bracket, and the locking mechanism 14 cooperates with the locking member 2003 on the battery pack 200, such that the battery pack 200 is connected to the first bracket. The first heating portion is at least arranged on the first bracket, and the first heating portion is configured to heat at least the locking mechanism 14, such that the first heating portion can consume lower energy to avoid the first bracket and the battery pack 200 from being frozen.

Step S1 also includes: if not, continuing to detect the trigger condition. With the above form, when the first preset trigger condition is not met, the first heating portion and the second heating portion are not started, and energy consumption is reduced. In addition, when the first preset trigger condition is not met, the trigger condition continues to be detected, thereby achieving real-time detection of the trigger condition and improving the accuracy of starting the first heating portion and the second heating portion. In addition, with the above control solution, the first heating portion and/or the second heating portion can be started in specific weather or at a specific temperature, thereby clarifying the heating scenes of the first heating portion and/or the second heating portion.

During specific use, the first preset trigger condition includes at least one of a first preset weather and a first preset temperature. Specifically, since weather and temperature have a great influence on whether the battery pack 200 is frozen on the quick-swap bracket 1, therefore, the above form can be adopted to better prevent the battery pack 200 and the quick-swap bracket 1 from being frozen together, such that the battery packs 200 can be quickly swapped normally in cold regions, and the efficiency of quick swapping of battery packs 200 in cold regions is improved. In this case, continuing to detect the trigger condition in step S1 means continuing to detect the current weather and temperature.

In other embodiments, the first preset trigger condition may also include other conditions, which are not limited herein.

Step S1 includes first determining whether the weather is a first preset weather condition, if so, then determining whether the temperature is lower than the first preset temperature, and if so, then determining that the first preset trigger condition is met. In this embodiment, the first preset weather condition includes rainy or snowy weather, and the first preset temperature is minus 2 degrees Celsius. Specifically, in rainy and snowy weather below a certain temperature, the battery pack 200 and the quick-swap bracket 1 are more easily frozen together, and rain or snow is a necessary condition for the battery pack 200 and the quick-swap bracket 1 to be frozen together. In other words, in the case of rain or snow, the battery pack 200 and the quick-swap bracket 1 are more easily frozen together, so first determining whether the weather is the first preset weather condition can better prevent the battery pack 200 and the quick-swap bracket 1 from being frozen together.

The electric vehicle 1000 includes a plurality of temperature detection members arranged corresponding to the locking mechanism 14 and the locking member 2003, to acquire the detection temperatures of the plurality of temperature detection members, and determine whether the detection temperature falls within a first preset temperature threshold. If so, the first heating portion and the second heating portion are started. Specifically, the locking member 2003 on the battery pack 200 cooperates with the locking mechanism 14 on the quick-swap bracket 1, such that the battery pack 200 is connected to the quick-swap bracket 1. With the above form, since the locking member 2003 is in direct contact with the locking mechanism 14, the detection temperature of the locking mechanism 14 and the locking member 2003 is detected, and whether the first heating portion and the second heating portion are started is determined according to the detection temperature, thereby better preventing the battery pack 200 and the quick-swap bracket 1 from being frozen together, making the battery packs 200 be quickly swapped normally, and improving the efficiency of quick swapping of battery packs 200 in cold regions. In addition, with the above form, the key positions including the locking member 2003 and the locking mechanism 14 can be directly heated, such that the heating efficiency of the first heating portion and the second heating portion is improved, and the first heating portion and the second heating portion can consume lower energy to avoid the quick-swap bracket 1 and the battery pack 200 from being frozen.

The first heating portion and the second heating portion that fall within the first preset temperature threshold in the first heating portion and the second heating portion are started. Specifically, in order to better prevent the quick-swap bracket 1 and the battery pack 200 from being frozen, each locking member 2003 and each locking mechanism 14 preferably have a corresponding temperature detection member to detect the temperature thereof, and a plurality of first heating portions connected to the quick-swap bracket 1 are arranged, and a plurality of second heating portions connected to the body of the battery pack 200 are arranged, such that each locking member 2003 and each locking mechanism 14 can be heated. Since whether each locking mechanism 14 and locking member 2003 are frozen and the freezing conditions between each locking mechanism 14 and each locking member 2003 are different, such differences can be reflected by the temperature detection results of each temperature detection member. Therefore, the detection results of the temperature detection member can be used to control whether each first heating portion and each second heating portion are started, as well as to adjust their operating power. For this embodiment, with the above form, only the first heating portion and/or the second heating portion that fall within the first preset temperature threshold are started, thereby reducing energy consumption and improving the accuracy of heating.

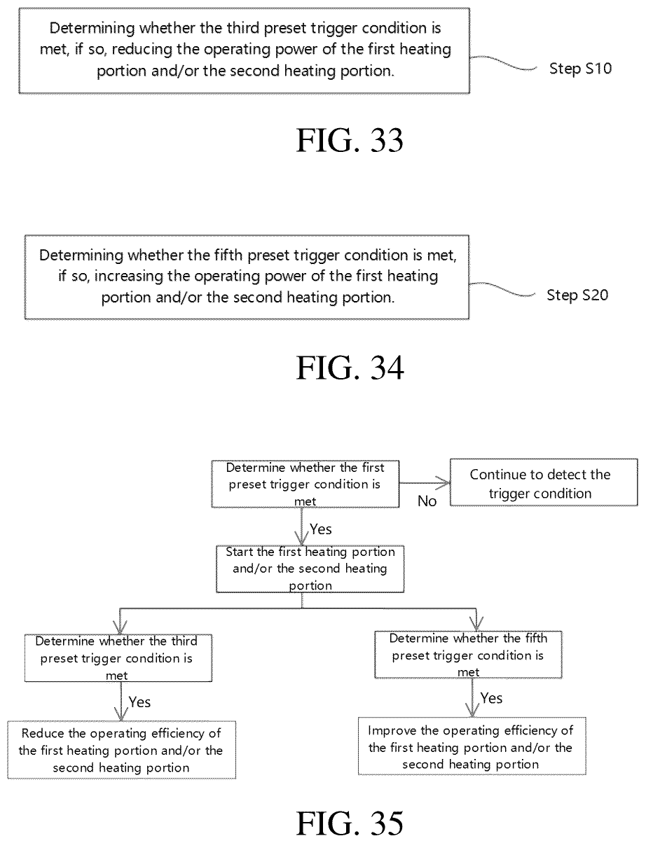

As shown in FIGS. 33 and 35, the control method includes:

Step S10: determining whether a third preset trigger condition is met, and if so, reducing the operating power of the first heating portion and the second heating portion. With the above form, the operating power of the first heating portion and the second heating portion is controlled by determining whether the trigger condition meets the third preset trigger condition, thereby ensuring that when the vehicle arrives at a charging station, the ice between the battery pack 200 and the quick-swap bracket 1 is just completely melted, making the battery packs 200 be quickly swapped normally, and improving the efficiency of quick swapping of battery packs 200 in cold regions.

The third preset trigger condition is determined based on the distance between the current vehicle and the charging station. Specifically, if the distance between the current vehicle and the charging station is far, the vehicle will have more time to start the first heating portion and the second heating portion, and the first heating portion and the second heating portion perform heating. In other words, when the distance between the current vehicle and the charging station is far, the heating time of the first heating portion and the second heating portion is longer. At this time, the operating power of the first heating portion and the second heating portion can be reduced to ensure that the vehicle arrives at the charging station, and the ice between the battery pack 200 and the quick-swap bracket 1 is just completely melted to reduce energy consumption.

In other embodiments, the third preset trigger condition is determined based on the remaining power of the vehicle. Specifically, when the remaining power of the vehicle is low, the heating power of the first heating portion and the second heating portion can be reduced, to ensure that the vehicle can drive to the destination normally. The above form can be adopted to prevent the battery pack 200 and the quick-swap bracket 1 from being frozen together, and the vehicle can also drive to the destination normally according to actual needs.

In other embodiments, the third preset trigger condition is determined comprehensively based on the distance between the current vehicle and the charging station and the remaining power of the vehicle. When the remaining power of the vehicle is low and the distance between the current vehicle and the charging station is far, the heating power of the first heating portion and the second heating portion can be reduced, to ensure that the vehicle can drive to the charging station normally; when the remaining power of the vehicle is sufficient and the distance between the vehicle and the charging station is far, the heating time of the first heating portion and the second heating portion is long. At this time, the operating power of the first heating portion and the second heating portion can be reduced to ensure that the vehicle arrives at the charging station, and the ice between the battery pack 200 and the quick-swap bracket 1 is just completely melted to reduce energy consumption.

As shown in FIGS. 34 and 35, the control method includes:

Step S20: determining whether a fifth preset trigger condition is met, and if so, increasing the operating power of the first heating portion and the second heating portion. In this solution, with the above form, the operating power of the first heating portion and the second heating portion is controlled by determining whether the trigger condition meets the fifth preset trigger condition, thereby ensuring that the current vehicle can arrive at the charging station with the remaining power, and further ensuring that the vehicle can drive normally.

The fifth preset trigger condition is determined based on the distance between the current vehicle and the charging station. Specifically, if the distance between the current vehicle and the charging station is short, the vehicle will have less time to start the first heating portion and the second heating portion, and the first heating portion and the second heating portion perform heating. In other words, when the distance between the current vehicle and the charging station is short, the heating time of the first heating portion and the second heating portion is short. At this time, the operating power of the first heating portion and the second heating portion can be increased to ensure that when the vehicle arrives at the charging station, the ice between the battery pack 200 and the quick-swap bracket 1 is just completely melted, such that the battery packs 200 can be quickly swapped normally, and the efficiency of quick swapping of battery packs 200 in cold regions is improved.

In other embodiments, the fifth preset trigger condition is determined based on the remaining power of the vehicle. When the remaining power of the vehicle is sufficient, the operating power of the first heating portion and the second heating portion can be increased, such that the ice between the battery pack 200 and the quick-swap bracket 1 can be melted faster, and the battery packs 200 can be quickly swapped normally in cold regions. The above form can be adopted to better prevent the battery pack 200 and the quick-swap bracket 1 from being frozen together while ensuring that the vehicle can drive normally, the battery packs 200 can be quickly swapped normally, and the efficiency of quick swapping of battery packs 200 in cold regions is improved.

In other embodiments, the fifth preset trigger condition is determined comprehensively based on the distance between the current vehicle and the charging station and the remaining power of the vehicle. When the remaining power of the vehicle is sufficient and the distance between the vehicle and the charging station is short, the operating power of the first heating portion and the second heating portion can be increased, such that when the vehicle arrives at the charging station, the ice between the battery pack 200 and the quick-swap bracket 1 can be melted, the battery packs 200 can be quickly swapped normally, and the efficiency of quick swapping of battery packs 200 in cold regions is improved.

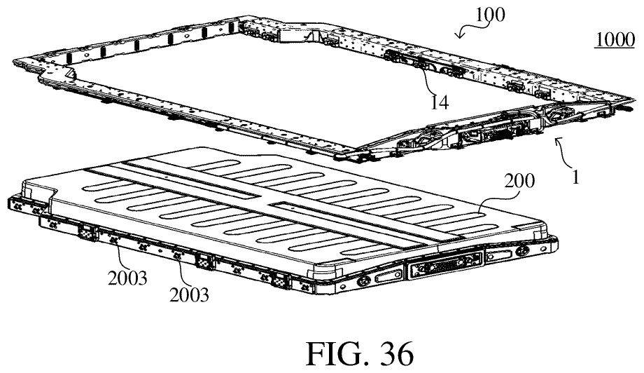

As shown in FIGS. 10 and 36, this embodiment further provides an electric vehicle 1000, the electric vehicle 1000 includes a quick-swap device 100, the quick-swap device 100 includes a quick-swap bracket 1 and a first heating portion, the first heating portion is connected to the quick-swap bracket 1 and is configured to heat the quick-swap bracket 1; and the electric vehicle 1000 includes a battery pack 200, the battery pack 200 includes a second heating portion, and the second heating portion is configured to heat the battery pack 200. Specifically, the battery pack 200 and the quick-swap device 100 are applied to the electric vehicle 1000, and the battery pack 200 is connected to the quick-swap bracket 1. With the above form, by determining whether a preset trigger condition is met, the quick-swap bracket 1 can be heated by the first heating portion; and the battery pack 200 can be heated by the second heating portion, to prevent the quick-swap bracket 1 and the battery pack 200 from being frozen under extreme weather such as extreme freezing rain or heavy snow, such that the battery pack 200 and the quick-swap bracket 1 can be separated normally, the battery packs 200 can be quickly swapped normally, and the efficiency of quick swapping of battery packs 200 in cold regions is improved. The above form avoids damage to the battery pack 200 and the quick-swap bracket 1 caused by forced battery swapping, and prolongs the service life of the battery pack 200 and the quick-swap bracket 1.

In this embodiment, the quick-swap bracket 1 is a body frame of the electric vehicle 1000 or the quick-swap bracket 1 is arranged on the body frame.

The first heating portion and the second heating portion are electrically connected to the vehicle power distribution box or the battery pack 200. With the above form, the first heating portion and/or the second heating portion can be powered by the vehicle power distribution box or the battery pack 200, thereby ensuring that the second heating portion can normally heat the quick-swap bracket 1, preventing the battery pack 200 and the quick-swap bracket 1 from being frozen, and ensuring normal battery swapping in cold regions.

In this embodiment, the first heating portion and the second heating portion are electrically connected to the vehicle power distribution box. In order to improve the safety of use, the first heating portion and the second heating portion preferably use low-voltage electricity.

In other embodiments, a battery can be arranged on the quick-swap bracket 1, and the battery is electrically connected to the battery pack 200 and the first heating portion and the second heating portion, respectively, such that the battery pack 200 can charge the battery and store the power in the battery, and when the first heating portion and the second heating portion need to be powered, the battery directly supplies power to the first heating portion and the second heating portion.

The electric vehicle 1000 further includes a temperature detection portion, and the temperature detection portion is configured to detect the temperatures of the quick-swap device 100 and the battery pack 200, such that the temperature of the quick-swap device 100 and the battery pack 200 can be detected in real time by the temperature detection portion, and the safety of heating is ensured.

The temperature detection portion includes a plurality of temperature detection members, and the plurality of temperature detection members are arranged corresponding to the locking mechanism 14 and the locking member 2003. With the above form, the temperature of the locking mechanism 14 and/or the locking member 2003 can be detected in real time by the temperature detection member, and the safety of heating is ensured. Preferably, the plurality of temperature detection members are arranged in one-to-one correspondence with the plurality of locking mechanisms 14 and the locking members 2003, such that each locking mechanism 14 and each locking member 2003 can be provided with a temperature detection member to detect the temperature thereof.

In this embodiment, the temperature detection member includes a grating sensor, and the grating sensor is characterized by high precision, thereby improving the detection accuracy.

Although specific embodiments of the present disclosure are described above, it should be understood by those skilled in the art that this is only for illustration and the protection scope of the present disclosure is defined by the appended claims. Those skilled in the art may make various changes or modifications to these embodiments without departing from the principles and essence of the present disclosure, but these changes and modifications shall all fall within the protection scope of the present disclosure.

1. A quick-swap device, comprising a quick-swap bracket and a first heating portion, wherein the first heating portion is connected to the quick-swap bracket and is configured to heat the quick-swap bracket.

2. The quick-swap device according to claim 1, wherein the quick-swap bracket comprises a first bracket and a locking mechanism, wherein the locking mechanism is arranged on the first bracket, the first heating portion is at least arranged on the first bracket, and the first heating portion is configured to heat at least the locking mechanism; and
preferably, the first bracket is provided with a first mounting surface for mounting the locking mechanism, the first heating portion is at least arranged on the first mounting surface, and/or the first heating portion is at least arranged on a side of the quick-swap bracket deviating from the first mounting surface.

3. The quick-swap device according to claim 2, wherein the first heating portion is wound around the first bracket along an extension direction of the first bracket; and
preferably, the first heating portion is spirally wound or directly wound around the first bracket along an extension direction.

4. The quick-swap device according to claim 2, wherein the locking mechanism comprises a plurality of lock bases, and an extension direction of the first heating portion is the same as a distribution direction of the plurality of lock bases;
preferably, the first heating portion includes a first heating member, and the first heating member is arranged at a corresponding position of the lock base to heat the lock base;
preferably, the first heating member is attached to the surface of the first bracket connected to the lock base; and/or
the first heating member is wound around the first bracket along a distribution direction of the lock base;
preferably, the first heating portion comprises a plurality of heating films, the heating films are connected to the surface of the first bracket, and the distribution of the plurality of heating films corresponds to the distribution of the plurality of lock bases; and
preferably, a plurality of heating films on the same side are connected in series;
preferably, the first heating portion further comprises connection members, and the plurality of heating films are electrically connected through the connection members; and
preferably, the connection member is located on a side of the first bracket deviating from the locking mechanism.

5. The quick-swap device according to claim 2, wherein the widths of the first heating portion along an extension direction of the first bracket are different; and
preferably, the width of the first heating portion close to the locking mechanism is greater than the widths of other regions.

6. The quick-swap device according to claim 2, wherein the first bracket comprises a first bracket body and at least one first bending portion, wherein the locking mechanism is arranged on the first bracket body, the first bending portion is bent from the first bracket body towards a direction away from the locking mechanism, the first bending portion extends along the length direction of the first bracket, and the first heating portion is arranged at the junction between the first bending portion and the first bracket body;
preferably, the first heating portion includes electric heating wires, a plurality of electric heating wires are arranged, and the plurality of electric heating wires are arranged in parallel at the junction between the first bending portion and the first bracket body; and/or
the first heating portion is arranged on a side of the first bracket body deviating from the locking mechanism.

7-8. (canceled)

9. The quick-swap device according to claim 2, wherein the first heating portion further comprises a PTC plate, the PTC plate is connected to the first bracket, and the distribution direction of the PTC plate is the same as the extension direction of the first bracket; and/or
the quick-swap bracket further comprises a second bracket, the first bracket and the second bracket enclose a frame structure, and the first heating portion is at least arranged on the second bracket;
preferably, the first heating portion is attached to the surface of the second bracket; and/or
the first heating portion is wound around the second bracket along an extension direction of the second bracket; and/or
the first heating portion is wound around extension directions of the first bracket and the second bracket.

10. (canceled)

11. The quick-swap device according to claim 1, wherein the first heating portion comprises one or more of an electric heating wire, a heating film, a heating plate, a heating belt, an electric heating belt, and a heating tracing belt.

12. A battery pack, comprising a second heating portion, wherein the second heating portion is configured to heat the battery pack.

13. The battery pack according to claim 12, wherein the battery pack comprises a battery pack body, and the second heating portion is connected to the battery pack body;
preferably, the battery pack comprises a locking member, the locking member is arranged on the battery pack body, and the second heating portion and the locking member are connected to the same side of the battery pack body;
preferably, a gap is formed between the second heating portion and the locking member; and/or
the battery pack comprises a positioning member spaced apart from the locking member, and a gap is formed between the second heating portion and the positioning member.

14. The battery pack according to claim 13, wherein the battery pack comprises a surrounding frame and a battery pack body, the surrounding frame is circumferentially arranged around the battery pack body, the surrounding frame is provided with an accommodation cavity, and the second heating portion is arranged in the accommodation cavity; and
preferably, the locking member is arranged on a side of the surrounding frame away from the battery pack body, and the second heating portion is arranged on a side of the accommodation cavity close to the locking member.

15. The battery pack according to claim 13, wherein the second heating portion is attached to the battery pack body or the surrounding frame; and/or
the second heating portion is wound around the locking member.

16. The battery pack according to claim 12, wherein the second heating portion is one or more of a heating plate, a heating belt, an electric heating belt, a heating film, a heating tracing belt, and an electric heating wire; and/or
the second heating portion includes a connection member and a plurality of heating films, and the plurality of heating films are electrically connected through the connection member; and/or
the heating film is provided with a through hole, and the through hole is configured to be sleeved on the locking member.

17. An electric vehicle, comprising the quick-swap device as described in claim 1.

18. The electric vehicle according to claim 17, wherein the quick-swap bracket is a body frame of the electric vehicle or is arranged on the body frame of the vehicle; and/or
the first heating portion and/or the second heating portion are electrically connected to a vehicle power distribution box or the battery pack; and/or
the electric vehicle further comprises a temperature detection portion, and the temperature detection portion is configured to detect the temperature of the quick-swap device and/or the battery pack;
preferably, the temperature detection portion comprises a plurality of temperature detection members, and the plurality of temperature detection members are arranged corresponding to the locking mechanism and/or the locking member; and
preferably, the temperature detection member comprises a grating sensor.

19. (canceled)

20. A control method for an electric vehicle applied to the electric vehicle according to claim 17, wherein the control method for the electric vehicle comprises:
determining whether a first preset trigger condition is met, and if so, starting the first heating portion and/or the second heating portion.

21. The control method for the electric vehicle according to 20, wherein the step of determining whether the first preset trigger condition is met further comprises: if not, continuing to detect the trigger condition; and/or
the first preset trigger condition includes at least one of a first preset weather and a first preset temperature;
preferably, determining whether the first preset trigger condition is met comprises first determining whether the weather is the first preset weather condition, and if so, then determining whether the temperature is lower than the first preset temperature, and if so, determining that the first preset trigger condition is met; and/or
the first preset weather condition includes rainy or snowy weather; and/or
the first preset temperature is minus 2 degrees Celsius.

22. (canceled)

23. The control method for the electric vehicle according to claim 20, wherein the electric vehicle comprises a plurality of temperature detection members arranged corresponding to the locking mechanism and/or the locking member, to acquire the detection temperatures of the plurality of temperature detection members, and determine whether the detection temperature falls within a first preset temperature threshold, if so, the first heating portion and/or the second heating portion are started; and
preferably, the first heating portion and/or the second heating portion falling within the first preset temperature threshold in the first heating portion and/or the second heating portion are started.

24. The control method for the electric vehicle according to claim 20, wherein the control method comprises:
determining whether a third preset trigger condition is met, and if so, reducing the operating power of the first heating portion and/or the second heating portion;
preferably, the third preset trigger condition is determined based on the distance between the current vehicle and the charging station;
preferably, the third preset trigger condition is determined based on the remaining power of the vehicle; and
preferably, the third preset trigger condition is determined comprehensively based on the distance between the current vehicle and the charging station and the remaining power of the vehicle.

25. The control method for the electric vehicle according to claim 20, wherein the control method comprises:
determining whether a fifth preset trigger condition is met, and if so, increasing the operating power of the first heating portion and/or the second heating portion;
preferably, the fifth preset trigger condition is determined based on the distance between the current vehicle and the charging station;
preferably, the fifth preset trigger condition is determined based on the remaining power of the vehicle; and
preferably, the fifth preset trigger condition is determined comprehensively based on the distance between the current vehicle and the charging station and the remaining power of the vehicle.
